(19) United States
(12) Patent Application Publication
(10) Pub. No.: US 2008/0260899 A1
(43) Pub. Date: Oct. 23, 2008

(54) Chewing Gum Piece and Process for Making the Same

(75) Inventors: Niels Ravn Schmidt, Barrit (DK); Mickey Damgaard Laursen, Vejle (DK); Per Henrik Ertebjerg Christensen, Odense SV (DK); Martin Topsoe, Vejle (DK); Jorn Holm Hansen, Juelsminde (DK)

Correspondence Address: CANTOR COLBURN, LLP, 20 Church Street, 22nd Floor, Hartford, CT, 06103, US

(73) Assignee: GUMLINK A/S, Vejle (DK)

(21) Appl. No.: 11/883,206

(22) PCT Filed: Jan. 28, 2005
(86) PCT No.: PCT/DK05/00066

§ 371 Date: Jul. 27, 2007

(51) Int. Cl. A23G 4/06

(52) U.S. Cl. 426/4

(57) ABSTRACT

The invention relates to a chewing gum piece comprising at least one inner filling (2) being enclosed by sugarless chewing gum substance (1), said chewing gum piece being provided with an anti-sticking agent (4), and said chewing gum piece being provided with a coating (6) at least partly encapsulating said chewing gum piece and said anti-sticking agent.

### FIELD OF THE INVENTION

The invention relates to a chewing gum piece according to claim 1 and a method for producing such a chewing gum.

### BACKGROUND OF THE INVENTION

Different variants of so-called center filled or liquid filled chewing gum is well-known within the art of chewing gum and several proposals to both structural and processing details related to manufacturing of such chewing gum is suggested in the written prior art.

However, different types of technical challenges have restricted the amount of center-filled chewing gum brought to market to be relatively low.

The invention is in particular concerned with sugarless or sugar free chewing gum. A particular problem related to sugar free or sugar less chewing gum is that the gum base content differs from that of conventionally sweetened chewing gum thereby introducing a somewhat more difficult process with respect to the manufacturing of chewing gum, in particular with respect to the process of preparing and manufacturing the individual pieces of chewing gum.

This problem is in particular problematic when dealing with e.g. so-called center-filled or liquid-filled sugar free or sugarless chewing gum when a subsequent coating is desired and such a coating has thus been avoided in conventional center-filled chewing gum due to the fact that a problematic leaking of the filling or liquid both prior to or during coating may occur.

A particular problem is furthermore that a coating is desired in order to obtain improved encapsulation properties but that the coating process in itself may tend to weaken or destroy the encapsulation.

It is the object of the invention to provide a sugar free or sugarless chewing gum having advantageous properties with respect to both texture and encapsulation.

A further problem is that the overall process of manufacturing a center-filled chewing gum may result in a relatively high wastage rate as both the step of processing the uncoated chewing gum pieces and the steps of coating the pieces involves increased wastage.

A further object of the invention is to avoid cooling or at least minimize cooling especially in the process step prior to the cutting and forming of the chewing gum pieces as cooling tends to increase brittleness of the encapsulation forming chewing gum substance.

### SUMMARY

The present invention relates to chewing gum pieces comprising at least one inner filling being enclosed by sugarless chewing gum substance, said chewing gum piece being provided with an anti-sticking agent, and said chewing gum piece being provided with a coating at least partly encapsulating said chewing gum piece and said anti-sticking agent.

According to an embodiment of the invention, the anti-sticking agent facilitates an advantageous coating of the chewing gum piece as the, typically water based, coating may tend to weaken or break the encapsulation of the inner filling. This is in particular important when considering the quality of the encapsulation provided subsequent to the extrusion of the endless chewing gum rope during the formation of the individual chewing gum chewing gum piece.

According to an embodiment of the invention, it should be noted, that the anti-sticking agent may be provided during the process of manufacturing a chewing gum piece according to the present invention. The process involves extrusion of a filled chewing gum rope, from which the chewing gum pieces are formed. The anti-sticking agent may typically be applied unto the chewing gum rope, and the chewing gum pieces formed from the rope may thus be covered by anti-sticking agent until they are coated by an outer coating covering the anti-sticking agent.

In an embodiment of the invention, said chewing gum piece comprises at least one substantially flat portion.

According the invention, an advantageous embodiment may be obtained, when the chewing gum piece comprises a flat (flattened) portion. Specifically, an advantage appears during the sorting and packing stages of the production process. In these stages, the concurrent handling of a lot of pieces has according to the present invention been found to be more convenient, when the pieces are provided with at least one flat portion. The existence of a flat portion of the tablets results in that the individual tablets may be oriented with respect to each other, thereby facilitating an evaluation and sorting of the manufactured chewing gum pieces prior to coating thereby avoiding unnecessary coating or even problems related to the coating process of useless or leaking chewing gum pieces.

The orientating may be established e.g. be mechanically feeding the pieces in certain tracks or using a dedicated feeder.

The flat portion(s) of the chewing gum tablet may be introduced as two opposite, substantially symmetric sides, which have been flattened by means of pressure by a piston. Alternatively or additionally, a flat portion of the chewing gum tablet may be constituted of a flat belt in the outward appearance of the chewing gum substance and thus in a circumference of the tablet.

In an embodiment of the invention, said chewing gum piece comprises at least two, substantially parallel, substantially flat portions.

In an embodiment of the invention, said chewing gum piece has flat areas comprising at least 5%, preferably at least 10%, and most preferably at least 20% of the total surface area of said chewing gum piece.

In an embodiment of the invention, said chewing gum substance comprises a polymer portion and at least two ingredients selected from the group comprising flavors, sweeteners, softeners, fillers, colorants, waxes, fats, surfactants, antioxidants, active ingredients, and combinations thereof.

In an embodiment of the invention, said polymer portion comprises at least one polymer.

In preferred embodiments of the invention, the polymer portion comprises one, two, three, or four polymers, while a higher number of polymers would be more unusual. However, in an embodiment of the invention a higher number of polymers may be applicable for adjusting the texture of the chewing gum substance in the chewing gum tablet.

In an embodiment of the invention, said chewing gum substance comprises a gum base, of which said polymer portion constitutes a main part.

Typically, the gum base comprises merely components, which are substantially water-insoluble. Thus, the gum base makes up a water insoluble part of the chewing gum substance.

In an embodiment of the invention, said gum base comprises 20 to 80%, preferably 30 to 60% by weight of the chewing gum substance.

In an embodiment of the invention, said gum base comprises bubblegum base in an amount of 2 to 100%, preferably 2 to 50%, and most preferably 2 to 15% by weight of the gum base.

In an embodiment of the invention, said gum base comprises polyvinyl acetate of high molecular weight (Mw) about 20000-70000 g/mol, preferably about 35000-65000 g/mol, and most preferably about 40000-60000 g/mol in an amount in the range of 0.1%-20%, preferably in the range of 0.2%-5% by weight of the chewing gum substance.

According to an embodiment of the invention, the presence of just a small percentage of polyvinyl acetate (PVA) of high molecular weight has a considerable influence on the elongation abilities of the chewing gum substance. Therefore, PVA may according to the invention be applied for obtaining a chewing gum texture, which is suitable for extrusion and enclosing an inner filling being at least partly liquid.

In an embodiment of the invention, said gum base comprises fat in an amount of 0.001% to 5%, preferably 0.002% to 2% by weight of the gum base.

In an embodiment of the invention, said gum base comprises high molecular weight elastomer of molecular weight about 300000 to 400000 g/mol in an amount of at most 3%, preferably at most 2% by weight of the chewing gum substance.

Both the gum base and chewing gum substance are very susceptible to regulations in the applied amount of high molecular weight elastomers. The texture of the chewing gum may change rather dramatically from relatively soft to relatively hard as a result of a quite small increase in percentage of high molecular weight elastomer, such as e.g. an increase from 5 to 7 percent by weight of the gum base.

In an embodiment of the invention, said chewing gum substance forms a wall enclosing said inner filling in substantially all directions.

In an embodiment of the invention, said wall has an average thickness in the range of about 0.5 to 10 mm, preferably about 1 to 5 mm, and most preferably 1.5 to 3 mm.

In an embodiment of the invention, said chewing gum substance comprises at least one active ingredient.

Generally, any desired active ingredients may be included in the chewing gum substance. A list of examples of active ingredients, also referred to as pharmaceutically, cosmetically or biologically active substances, is given in the detailed description of the present invention.

It may be desired to incorporate two, three or more different active ingredients in one filled chewing gum piece according to the invention.

In an embodiment of the invention, said at least one active ingredient is comprised in said gum base.

According to an embodiment of the invention, it may be preferred to incorporate some active ingredients into the gum base part of the chewing gum substance, e.g. in order to obtain a slower release rate of these particular active ingredients.

In an embodiment of the invention, said chewing gum substance comprises at least one biodegradable polymer.

In an embodiment of the invention, said at least one biodegradable polymer comprises a polyester.

In an embodiment of the invention, said polyester is obtainable from ring-opening polymerization of one or more cyclic esters.

In an embodiment of the invention, said polyester is obtainable from polymerization of at least one alcohol or derivative thereof with at least one carboxylic acid or derivative thereof.

In an embodiment of the invention, said chewing gum substance comprises at least two different polyesters.

The at least two different polyesters may be at least one, which has been obtained from ring-opening polymerization and at least one having been obtained by polymerization of alcohols and carboxylic acids or derivatives of these components. Alternatively, the at least two different polyesters may have been obtained by similar polymerization reactions while still being based on different monomers.

In an embodiment of the invention, said chewing gum piece weighs in the range of 0.5 to 8 grams, preferably 1 to 5 grams, and most preferably 1.5 to 3 grams.

In an embodiment of the invention, said chewing gum piece is shaped as a pellet, chunk, stick, cushion, pastille, ball, pill, or sphere.

In an embodiment of the invention, said inner filling comprises in the range of 2 to 40%, preferably 5 to 20%, and most preferably 8 to 15% by weight of said chewing gum piece.

In an embodiment of the invention, said inner filling is at least partially solid at a temperature of at most 5° C.

Correspondingly, the filling is in an embodiment of the invention in a liquid state at temperatures above 5° C., or at least temperatures above 15° C. An advantage hereof may be that the consumer may enjoy a chewing gum with a liquid filling, even at relatively cold temperatures in the surroundings.

In an embodiment of the invention, said inner filling is at least partially solid at temperatures up to 30° C.

According to an embodiment of the invention, an advantageous product may be obtained, when the filling of the tablet is in an at least moderately solid state at temperatures in which the chewing gum is normally stored. Thereby leaking of liquid filling material may be avoided, even if the chewing gum substance should accidentally contain a hole or crack of some kind. Furthermore, consumers may according to some embodiments of the invention appreciate it, when the filling is initially moderately solid and then melts when kept in the mouth for a while, such as a few seconds or minutes.

Generally, the application of anti-sticking agent may be of great advantage, when handling chewing gum rope with liquid filling. This advantage relies on the fact that liquid filling material, which accidentally leaks during the production process, may increase the stickiness drastically. This problem has been found to be considerably reduced by the application of anti-sticking agent according to the invention.

In an embodiment of the invention, said inner filling comprise components selected from the group comprising syrups, pastes, powders, and mixtures thereof.

In an embodiment of the invention, said inner filling has a viscosity in the range of 0.6 to 200000, preferably 100 to 100000 mPa*s as measured at 40° C.

In an embodiment of the invention, said inner filling comprises at least one sweetener and at least one flavor.

It should be noted that all the sweeteners and flavorings mentioned in the detailed description of the present invention as chewing gum ingredients may in fact be applied in the filling material as well.

In an embodiment of the invention, said inner filling comprises at least one sweetener selected from the group comprising mannitol, xylitol, hydrogenated starch hydrolysates, maltitol, isomaltol, erythritol, lactitol, glycerol, sucrose, dextrose, maltose, dextrins, trehalose, D-tagatose, invert sugar, fructose, levulose, galactose, corn syrup, sucralose, aspartame, salts of acesulfame, alitame, neotame, twin sweet, saccharin and its salts, cyclamic acid and its salts, isomalt, dihydrochalcones, glycyrrhizin, dihydrochalcones, thaumatin, monellin, talin, stevioside, and mixtures thereof.

Generally, the filling may according to an embodiment of the invention be described as a material comprising a mixture of several ingredients including a kind of syrup and flavor.

In an embodiment of the invention, said inner filling comprises at least one flavoring agent selected from the group comprising essential oils, fruit flavors, peppermint, spearmint, wintergreen, cinnamon, lemon, orange, lime, grapefruit, grape, strawberry, pineapple, cherry, apple, and mixtures thereof.

In an embodiment of the invention, said inner filling comprises active ingredients.

Generally, any desired active ingredients may be included in the filling. A list of examples of active ingredients, also referred to as pharmaceutically, cosmetically or biologically active substances, is given in the detailed description of the present invention.

In an embodiment of the invention, said inner filling is situated at least approximately in the center of said chewing gum piece.

It is within the scope of the present invention that chewing gum tablets according to the present invention may comprise a filling, which is displaced from the actual center of the chewing gum tablet due to production methods or due to the shape of the chewing gum tablet.

In an embodiment of the invention, said inner filling is situated in at least two partly separated compartments in said chewing gum piece.

These compartments are herein defined as sections or rooms filled with filling material as exemplified above, and separated by chewing gum substance. The chewing gum substance thus functions as a kind of wall material between the filled compartments in the chewing gum tablet according to an embodiment of the present invention.

In some embodiments of the invention, it may be preferred to incorporate multiple, such as three, four, six, seven, etc. filled compartments in a chewing gum tablet. Hereby, a nice and marked taste and texture sensation may be experienced when chewing the chewing gum tablet.

Ways of obtaining separate filled compartments, such as two or three filled compartments in the chewing gum tablet, may for example involve co- or triple-extrusion.

In an embodiment of the invention, said anti-sticking agent is located on the outside of said chewing gum piece and on the inside of said coating.

The anti-sticking agent serves to prevent sticking to machinery during the manufacturing procedure of the filled chewing gum tablet of the present invention. A further effect of the anti-sticking agent is that sticking of the chewing gum tablets to each other may be avoided.

The sugarless or sugar free chewing gum substance applied according to the present invention has relatively marked stickiness compared to conventional sugar-containing chewing gum. Yet, the above-mentioned advantages, owing to the anti-sticking agent, may be obtained. In fact the anti-sticking agent has been found to be even more important, when the production is carried out with sugarless chewing gum than with sugar-containing chewing gum.

Furthermore, the anti-sticking agent has an important function, when the chewing gum tablets of the invention are manufactured in relatively small sizes considering the fact that they may actually be filled with an at least partly liquid filling. When reducing the size of the filled chewing gum tablets of the present invention, leaking may occur more frequently, and the anti-sticking agent attains an important function as a mean, by which sticking of the chewing gum substance to the machines may be prevented.

An important advantage of applying anti-sticking agent is that sticking-problems may be solved, while keeping the manufacturing temperature relatively high. In the absence of an anti-sticking agent, a way of avoiding the stickiness of the chewing gum could be a lowering of the temperature, which would often cause other problems including leakage problems and problems of obtaining enough stretching ability in the chewing gum substance. Thus, anti-sticking agent is indirectly a way of avoiding these problems.

The location of the anti-sticking agent may be described as being between the tablet surface and a layer of coating material applied on the tablet. In other words, anti-sticking agent has been applied to the tablet surface first, and the coating afterwards. The coating serves among other things to cover the anti-sticking agent to thereby provide a pleasant initial sensation, when a consumer has a new piece of chewing gum, i.e. the filled chewing gum piece of the present invention.

In an embodiment of the invention, said anti-sticking agent is selected from the group comprising calcium hydroxide, talc, D-mannitol, silicon dioxide, sucrose ester, calcium stearate, zink stearate, magnesium stearate, and other metallic stearates, polyoxyethylene monostearates, silicates, polyethylene glycols, silicate dioxide, fumed silica, stearic acid, calcium carbonate, and mixtures thereof.

Some compounds such as some metallic stearates, e.g. magnesium stearate, may be useful as anti-sticking agents but might not be preferred due to a relatively high price compared to other alternatives, such as talc.

It should furthermore be noted, that oily or fatty lubricant agents, such as for example vegetable oils and animal fats, are not suitable as anti-sticking agents according to the present invention. This notion is based on the fact that such lubricants have been found to have an at least slightly dissolving effect of the chewing gum substance, and thereby they may cause the surface on the chewing gum piece to be un-suitable for coating

In an embodiment of the invention, said coating is selected from the group comprising hard coatings, soft coatings, and film coatings.

In an embodiment of the invention, said coating comprises about 1 to about 85% by weight of the complete coated chewing gum piece.

Suitable coating types include hard coatings, film coatings and soft coatings of any composition including those currently used in coating of chewing gum, pharmaceutical products and confectioneries. Active ingredients may be incorporated in the coating of the chewing gum piece.

In an embodiment of the invention, said coating is formed from layers of liquid suspensions applied consecutively in 1 to 100 coating cycles. The coating may be performed as a continuous process, that is, there may actually only be one coating cycle. Alternatively, the coating may be performed batch wise, each batch of chewing gum pieces being exposed to repeated cycles of applying coating solution.

In an embodiment of the invention, said coating comprises ingredients selected from the group of polyols, high intensity sweeteners, flavors, and active ingredients.

According to the invention, each of these ingredients may be selected from those listed in the detailed description, below, as ingredients for chewing gum.

In an embodiment of the invention, said coating is sugarless or sugar free.

In an embodiment of the invention, said coating is a hard coating comprising at least one polyol component selected from the group comprising sorbitol, maltitol, mannitol, xylitol, erythritol, lactitol, isomalt, and mixtures thereof.

In an embodiment of the invention, said coating is a film-coating comprising at least one component selected from the group comprising wax, cellulose derivatives, a modified starches, dextrins, gelatine, shellac, gum arabics, zein, vegetable gums, synthetic polymers, and mixtures thereof.

In an embodiment of the invention, the chewing gum piece is formed on the basis of a substantially non-cooled chewing gum material.

According to a preferred embodiment of the invention, the term non-cooling preferably refers to avoidance or minimizing active cooling prior to forming and cutting of the chewing gum pieces.

The confectionery product according to the invention is suitable for almost any coating method within the art, such as hard coating, film coating, soft coating, etc.

In a further advantageous embodiment of the invention, several layers of coatings may be applied, and the layers may comprise or be formed by different types of layer substance.

In an advantageous embodiment of the invention, chocolate may be applied as a coating, a product module or center filling as the polymer system has proved robust to such quite aggressive plasticizing component, which typically tends to dissolve conventional chewing gum formulations.

One presently preferred outer coating type is a hard coating, which term is used in the conventional meaning of that term including sugar coatings and sugar-free (or sugarless) coatings and combinations thereof. The object of hard coating is to obtain a sweet, crunchy layer which is appreciated by the consumer and to protect the confectionery product centers for various reasons as. In a typical process of providing the chewing gum piece with a protective sugar coating the chewing gum pieces are successively treated in suitable coating equipment with aqueous solutions of crystallisable sugar such as sucrose or dextrose, which, depending on the stage of coating reached, may contain other functional ingredients, e.g. fillers, colors, etc. In the present context, the sugar coating may contain further functional or active compounds including flavor compounds, pharmaceutically active compounds and/or polymer degrading substances.

In the production of confectionery product according to the present invention it is however strongly preferred to replace the cariogenic sugar compounds in the coating by other, preferably crystallisable, sweetening compounds that do not have a cariogenic effect. In the art such coatings are generally referred to as sugarless or sugar-free coatings. Presently preferred non-cariogenic hard coating substances include polyols, e.g. sorbitol, maltitol, mannitol, xylitol, erythritol, lactitol, isomalt and tagatose which are obtained by industrial methods by hydrogenation of D-glucose, maltose, fructose or levulose, xylose, erythrose, lactose, isomaltulose and D-galactose, respectively.

In a typical hard coating process, as it will be described in details in the following, syrup containing crystallisable sugar and/or polyol is applied onto the confectionery product centers and the water it contains is evaporated off by blowing with warm, dry air. This cycle must be repeated several times, typically 10 to 80 times, in order to reach the swelling required. The term “swelling” refers to the increase in weight of the products, as considered at the end of the coating operation by comparison with the beginning, and in relation to the final weight of the coated products. In accordance with the present invention, the coating layer constitutes for example about 1 to 75% by weight of the finished confectionery product, such as about 10 to 60% by weight, including about 15 to 50% by weight.

In further useful embodiments the outer coating of the confectionery product element of the invention is an element that is subjected to a film coating process and which therefore comprises one or more film-forming polymeric agents and optionally one or more auxiliary compounds, e.g. plasticizers, pigments and opacifiers. A film coating is a thin polymer-based coating applied to a confectionery product center of any of the above forms. The thickness of such a coating is usually between 20 and 100 μm. Generally, the film coating is obtained by passing the confectionery product centers through a spray zone with atomized droplets of the coating materials in a suitable aqueous or organic solvent vehicle, after which the material adhering to the confectionery product centers is dried before the next portion of coating is received. This cycle is repeated until the coating is complete.

In the present context, suitable film-coating polymers include edible cellulose derivatives such as cellulose ethers including methylcellulose (MC), hydroxyethyl cellulose (HEC), hydroxypropyl cellulose (HPC) and hydroxypropyl methylcellulose (HPMC). Other useful film-coating agents are acrylic polymers and copolymers, e.g. methylacrylate aminoester copolymer or mixtures of cellulose derivatives and acrylic polymers. A particular group of film-coating polymers also referred to as functional polymers are polymers that, in addition to its film-forming characteristics, confer a modified release performance with respect to active components of the confectionery product formulation. Such release modifying polymers include methylacrylate ester copolymers, ethylcellulose (EC) and enteric polymers designed to resist the acidic stomach environment, yet dissolve readily in the duodenum. The latter group of polymers includes: cellulose acetate phthalate (CAP), polyvinyl acetate phthalate (PVAP), shellac, metacrylic acid copolymers, cellulose acetate trimellitate (CAT) and HPMC. It will be appreciated that the outer film coating according to the present invention may comprise any combination of the above film-coating polymers.

The choice of film-forming polymer(s) and plasticizing agent(s) for an optional outer coating of the present confectionery product is made with due consideration for achieving the best possible barrier properties of the coating in respect of dissolution and diffusion across the film of moisture and gasses.

The film coating of the confectionery product elements may also contain one or more colorants or opacifiers. In addition to providing a desired color, such agents may contribute to protecting the confectionery product against pre-chewing reactions, in particular by forming a barrier against moisture and gasses. Suitable colorants/pacifiers include organic dyes and their lakes, inorganic coloring agents, e.g. titanium oxide and natural colors such as e.g. β-carotene.

Additionally, film coatings may contain one or several auxiliary substances such as flavors and waxes or saccharide compounds such as polydextrose, dextrins including maltodextrin, lactose, modified starch, a protein such as gelatine or zein, a vegetable gum and any combination thereof.

It is also an aspect of the present invention that the outer coating of the confectionery product can contain one or more pharmaceutically or cosmetically components including those mentioned hereinbefore.

Accordingly, in further embodiments, a above hard-coated or film-coated confectionery product element of the invention is an element where the outer coating comprises at least one additive component selected from a binding agent, a moisture absorbing component, a film forming agent, a dispersing agent, an anti-sticking component, a bulking agent, a flavoring agent, a coloring agent, a pharmaceutically or cosmetically active component, a lipid component, a wax component, a sugar, and an acid. If it is desired to defer the effect of any of these additive components in the outer coating until mastication of the confectionery product, such components may, in accordance with the invention be encapsulated using any conventional encapsulation agent such as e.g. a protein including gelatine and soy protein, a cellulose derivative including any of those mentioned above, a starch derivative, edible synthetic polymers and lipid substances, the latter optionally in the form of liposome encapsulation.

In other embodiments, the confectionery product element according to the invention is provided with an outer coating in the form generally described in the art as a soft coating. Such soft coatings are applied using conventional methods and may advantageously consist of a mixture of a sugar or any of the above non-cariogenic, sugar-less sweetening compounds, and a starch hydrolysate.

It should be noted that the above-described coating may be postponed until it fits into the last part of the manufacturing process due to the fact that the applied barrier layer is also acting as a complete or at least a partial barrier to transfer of humidity from the environment into the tablet.

The present invention further relates to a method of manufacturing chewing gum pieces comprising the steps of continuously extruding sugarless or sugar free chewing gum substance rope comprising an inner filling from an extruder to a tablet forming arrangement, said tablet forming arrangement continuously forming and cutting chewing gum pieces from said rope,

continuously providing an anti-sticking agent to said rope subsequent to said extrusion and at least simultaneously or prior to said forming and cutting, providing a sugarless or sugar free coating to said chewing gum pieces by means of a coater.

According to the invention, the tablet forming arrangement may be provided with means for cutting, die cutting, punching, or stamping.

The present invention further relates to a method of manufacturing a chewing gum piece according to any of the claims 1-44.

In an embodiment of the invention, said method further comprises the step of rope sizing said chewing gum substance rope by means of at least one rope sizer subsequent to said extrusion and prior to said forming and cutting.

In an embodiment of the invention, a rope-sizing mechanism us used after the extruder in order to reduce the diameter of the filled chewing gum rope.

In an embodiment of the invention, said anti-sticking agent is applied at two or more positions during said method.

In an embodiment of the invention, said anti-sticking agent is applied prior or simultaneously to said rope sizing.

In an embodiment of the invention, said anti-sticking agent is applied on the way out of said extruder.

In an embodiment of the invention, said anti-sticking agent is applied onto the surface of the chewing gum substance rope.

In an embodiment of the invention, said anti-sticking agent is applied onto a part of said rope sizer or tablet-forming arrangement being in contact with said chewing gum substance rope.

In an embodiment of the invention, said anti-sticking agent is applied by a conditioning arrangement by spraying, dusting, or smearing.

In an embodiment of the invention, said extrusion and said forming and cutting is performed substantially without cooling.

In an embodiment of the invention, said extruder, rope sizer, and tablet forming arrangement are operated at a temperature of at least 30° C., preferably at least 35° C., and most preferably at least 40° C.

The operating temperature may in an embodiment of the invention be below 120° C., preferably below 80° C.

In an embodiment of the invention, said chewing gum pieces are cooled prior to coating or storage to a temperature of at most 30° C., preferably at most 25° C.

In an embodiment of the invention, said chewing gum substance rope has a diameter in the range of 5 to 50 mm, preferably in the range of 8 to 25 mm, and most preferably in the range of 10 to 20 mm.

In an embodiment of the invention, said chewing gum substance forms a wall surrounding said inner filling.

In an embodiment of the invention, said wall has a thickness in the range of 0.5 to 10 mm, preferably 1 to 5 mm, and most preferably 1.5 to 3 mm.

The wall thickness is here meant to be the final wall thickness of the rope-sized filled chewing gum substance rope and the wall thickness of the final filled chewing gum piece.

### THE FIGURES

The invention will now be described with reference to the drawings of which

FIG. 1A-1C illustrate the process steps relating to continuous forming of the filled chewing gum pieces according to the present invention,

FIG. 2A-2D illustrate cross sectional views of extruded chewing gum rope with inner filling,

FIG. 3A-3H illustrate examples of different shapes of the filled chewing gum pieces according to the present invention, and

FIG. 4A-4B illustrate examples in principle of chewing gum pieces with inner filling, chewing gum substance, anti-sticking agent and coating.

### DETAILED DESCRIPTION

Many aspects may be taken into consideration, when dealing with filled chewing gum according to the invention. Here below is given a detailed description of the components and process involved, when manufacturing filled chewing gum pieces according to the present invention.

Chewing gum pieces according to the present invention comprise a sugarless or sugar free chewing gum substance, which encapsulates an inner filling. Furthermore, an anti-sticking agent is provided on the outer surface of the chewing gum substance during the process of manufacturing uncoated filled chewing gum pieces. Afterwards, the chewing gum pieces are provided with an outer protective coating, which in addition may present a pleasant taste and initial sensation, when chewing a filled chewing gum piece according to the present invention.

In general, the composition of chewing gum substance according to the invention typically comprises a water-soluble bulk portion, a water-insoluble chewable gum base portion, and flavoring agents. The water-soluble portion dissipates with a portion of the flavoring agent over a period of time during chewing. The gum base portion is retained in the mouth throughout the chew. The term chewing gum refers to both a chewing and bubble type gum in its general sense.

In addition to the water insoluble gum base portion, the chewing gum substance applied according to the present invention typically includes one or more flavoring agents and a water soluble bulk portion, which may include bulk sweeteners, high intensity sweeteners, flavoring agents, softeners, emulsifiers, colors, acidulants, fillers, antioxidants, and other components that provide desired attributes.

Turning first to the water-insoluble gum base part, which forms the masticatory part of the final chewing gum substance, and which imparts the chew characteristics to the final product. The gum base typically defines the release profile of flavors, and sweeteners and plays a significant role in the gum product.

The water-insoluble portion of the gum typically may contain any combination of elastomers, vinyl polymers, elastomer plasticizers, waxes, softeners, fillers and other optional ingredients such as colorants and antioxidants. The gum base portion may constitute about 5 to 95 percent by weight of the chewing gum substance, more commonly, the gum base comprises about 10 to 50 percent of the chewing gum substance.

The composition of gum base formulations can vary substantially depending on the particular product to be prepared and on the desired masticatory and other sensory characteristics of the final product. However, typical ranges (weight %) of the above gum base components are: 5 to 50% by weight elastomeric compounds, 5 to 55% by weight elastomer plasticizers, 0 to 40% by weight of waxes, 5 to 35% by weight softener, 0 to 50% by weight filler, and 0 to 5% by weight of miscellaneous ingredients such as antioxidants, colorants, etc.

Elastomers provide the rubbery, cohesive nature to the gum, which varies depending on this ingredient's chemical structure and how it may be compounded with other ingredients. Elastomers suitable for use in the gum base and gum of the present invention may include natural or synthetic types.

The elastomer may be any water-insoluble polymer known in the art, and includes those gum polymers utilized for chewing gum and bubble gum listed in Food and Drug Administration, CFR, Title 21, Section 172,615, as “Masticatory Substances of Natural Vegetable Origin” and “Masticatory Substances, Synthetic”

Useful natural elastomers include natural rubber such as smoked or liquid latex and guayule, natural gums such as jelutong, lechi caspi, perillo, sorva, massaranduba balata, massaranduba chocolate, nispero, rosidinha, chicle, gutta percha, gutta kataiu, niger gutta, tunu, chilte, chiquibul, gutta hang kang.

Useful synthetic elastomers include high molecular weight elastomers such as butadiene-styrene copolymers, polyisobutadiene and isobutylene-isoprene copolymers, low molecular weight elastomers such as polybutene, polybutadiene and polyisobutylene, vinyl polymeric elastomers such as polyvinyl acetate, polyethylene, vinyl copolymeric elastomers such as vinyl acetate/vinyl laurate, vinyl acetate/vinyl stearate, ethylene/vinyl acetate, polyvinyl alcohol or mixtures thereof. In general, some preferred low molecular weight elastomers have molecular weights in the range of 40000-60000 g/mole (Mw), while some preferred high molecular weight elastomers cover the range of 250000-450000 g/mole (Mw).

Butadiene-styrene type elastomers, or SBR as they may be called, typically are copolymers of from about 20:80 to 60:40 styrene:butadiene monomers. The ratio of these monomers affects the elasticity of the SBR as evaluated by mooney viscosity. As the styrene:butadiene ratio decreases, the mooney viscosity decreases.

The structure of SBR typically consists of straight chain 1,3-butadiene copolymerized with phenylethylene (styrene) and provides the non-linear molecular nature of these elastomers. The average molecular weight of SBR is <600000 g/mole.

Isobutylene-isoprene type elastomers, or butyl as they may be called, have molar percent levels of isoprene ranging from 0.2 to 4.0. Similar to SBR, as the isoprene:isobutylene ratio decreases, so does the elasticity, measured by mooney viscosity.

The structure of butyl rubber typically consists of branched 2-methyl-1,3-butadiene (isoprene) copolymerized with branched 2-methylpropene (isobutylene), and, as with SBR, this type of structure is non-linear in nature. The average molecular weight of SBR is in the range from 150000 g/mole to 1000000 g/mole.

Polyisobutylene, or PIB as they may be called, type elastomers are polymers of 2-methylpropene and, as with SBR and butyl, are non-linear in nature. The low molecular weight elastomers provide soft chew characteristics to the gum base and still provide the elastic qualities, as do the other elastomers. Average molecular weights may range from about 30000 to 120000 g/mole and the penetration may range from about 4 millimeters to 20 millimeters. The higher the penetration, the softer the PIB. Similar to the SBR and butyl, the high molecular weight PIB elastomers provide elasticity the gum, and their average molecular weight may range from 120000 to 1000000 g/mole.

Polybutenes range in average molecular weight from about 5000 g/mole to about 30000 g/mole.

Vinyl polymeric and copolymeric type elastomers provide tack resistance, vary the chew characteristics of gums made from these bases having vinyl polymers and offer hydrophilic properties beneficial to sensory perception of the final gums.

For vinyl copolymeric types, the amount of vinyl laurate, vinyl stearate, or ethylene present in the vinyl laurate/vinyl acetate (VL/VA), vinyl stearate/vinyl acetate (VS/VA), or ethylene/vinyl acetate (EVA) copolymers respectively typically ranges from about 10 to about 60 percent by weight of the copolymer. Average molecular weights of these polymers may range from about 2000 g/mole to about 100000 g/mole.

The vinyl polymers such as polyvinyl alcohol and polyvinyl acetate may have an average molecular weight from about 7000 g/mole to about 65000 g/mole. Polymers of vinyl acetate (PVA), are branched in nature. The degree of branching is increased when vinyl acetate monomers are copolymerized with vinyl laurate, vinyl stearate, ethylene and the like. The higher the degree of branching, the higher the compatibility when blended or compounded with normal-alkanic and iso-alkanic type waxes. The desired consistency of the gum base and chewing gum substance for the filled chewing gum pieces of the present invention may be obtained by combining high and low molecular weight PVA in the gum base. In this case, low molecular weight PVA covers 7000-17000 g/mole (Mw), while high molecular weight PVA covers 40000-60000 g/mole (Mw). Alternatively, only one PVA-polymer may be applied in the gum base having an intermediate molecular weight such as 20000-35000 g/mole.

It is e.g. common in the industry to combine in a gum base a synthetic elastomer having a high molecular weight and a low-molecular-weight elastomer. Presently preferred combinations of synthetic elastomers include, but are not limited to, polyisobutylene and styrene-butadiene, polyisobutylene and polyisoprene, polyisobutylene and isobutylene-isoprene copolymer (butyl rubber) and a combination of polyisobutylene, styrene-butadiene copolymer and isobutylene isoprene copolymer, and all of the above individual synthetic polymers in admixture with polyvinyl acetate, vinyl acetate-vinyl laurate copolymers, respectively and mixtures thereof.

Elastomer plasticizers vary the firmness of the gum base. Their specificity on elastomer inter-molecular chain breaking (plasticizing) along with their varying softening points cause varying degrees of finished gum firmness and compatibility when used in base. This may be important when one wants to provide more elastomeric chain exposure to the alkanic chains of the waxes.

The vinyl polymers such as PVA may imply at least some of the elastomer plasticizing function, and further elastomer plasticizers suitable for use in the present invention include natural rosin esters often referred to as ester gums. Such elastomer plasticizers known in the art, are, methyl, glycerol and pentaerythritol esters of rosins and modified rosins, such as hydrogenated, dimerized and polymerized rosins. Examples are, glycerol ester of wood and gum rosin, glycerol ester of partially hydrogenated wood and gum rosin, glycerol ester of polymerized wood and gum rosin, glycerol ester of partially dimerized wood and gum rosin, glycerol ester of tall oil rosin, pentaerythritol ester of wood and gum rosin, pentaerythritol esters of partially and fully hydrogenated wood and gum rosin, methyl esters of wood and gum rosins and partially and fully hydrogenated methyl esters of wood and gum rosin.

Useful synthetic elastomer plasticizers include terpene resins derived from alpha-pinene, beta-pinene and/or d-limonene.

The elastomer plasticizers used may be of one type or of combinations of more than one type. Typically, the ratios of one to the other are dependent on each respective softening point, the effect on flavor release, and the respective degree of tack they cause to the gum. Ball and ring softening points of the rosin ester types described above may range from about 45° C. to about 120° C. Softening points of the terpene resins may range from about 60° C. to about 130° C.

The chewing gum substance applied in the filled chewing gum piece according to the present invention may comprise biodegradable polymers. If biodegradable polymers are applied, they may constitute an amount of 10 to 100% by weight of the gum base.

In the present context, the term biodegradable polymer refers to chewing gum base polymers which, after dumping the chewing gum, are capable of undergoing a physical, chemical and/or biological degradation whereby the dumped chewing gum waste becomes more readily removable from the site of dumping or is eventually disintegrated to lumps or particles which are no longer recognizable as being chewing gum remnants. The degradation or disintegration of such degradable polymers can be effected or induced by physical factors such as temperature, light, moisture, by chemical factors such as hydrolysis caused by a change in pH or by the action of enzymes capable of degrading the polymers.

Some biodegradable polymers suitable according to the present invention may include polymers obtained by ring-opening polymerization of cyclic esters or carbonates, and polyesters obtained by the polymerization of multi-functional alcohols or derivatives thereof with multi-functional carboxylic acids or derivatives thereof.

Regarding the polyesters obtained by ring-opening polymerization of one or more cyclic esters, their monomers may generally include glycolides, lactides, lactones and/or carbonates. The polymerization process may take place in the presence of at least one appropriate catalyst such as metal catalysts, of which stannous octoate is a non-limiting example and the polymerization process may be initiated by initiators such as polyols, polyamines or other molecules with multiple hydroxyl or other reactive groups and mixtures thereof.

Examples of polyester polymers of this type include, but are not limited to: Poly (L-lactide); poly (D-lactide); poly (D, L-lactide); poly (mesolactide); poly (glycolide); poly (trimethylenecarbonate); poly (epsilon-caprolactone); poly (L-lactide-co-D, L-lactide); poly (L-lactide-co-meso-lactide); poly (L-lactide-co-glycolide); poly (L-lactide-co-trimethylenecarbonate); poly (L-lactide-co-epsilon-caprolactone); poly (D, L-lactide-co-meso-lactide); poly (D, L-lactide-co-glycolide); poly (D, L-lactide-co-trimethylenecarbonate); poly (D, L-lactide-co-epsilon-caprolactone); poly (meso-lactide-co-glycolide); poly (meso-lactide-co-trimethylenecarbonate); poly (meso-lactide-co-epsilon-caprolactone); poly (glycolide-cotrimethylenecarbonate) poly (glycolide-co-epsilon-caprolactone).

Further specific examples of monomers, which may be applied in the polyester polymers of this type include the lactone monomers such as ε-caprolactone, δ-valerolactone, γ-butyrolactone, and β-propiolactone, also including ε-caprolactones, δ-valerolactones, γ-butyrolactones, or β-propiolactones that have been substituted with one or more alkyl or aryl substituents at any non-carbonyl carbon atoms along the ring. Furthermore specific monomer examples include the carbonate monomers such as trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one, ethylene carbonate, 3-ethyl-3-hydroxymethyl, propylene carbonate, trimethylolpropane monocarbonate, 4,6-dimethyl-1,3-propylene carbonate, 2,2-dimethyl trimethylene carbonate, and 1,3-dioxepan-2-one.

As regards the polyesters prepared from alcohol or derivatives thereof and carboxylic acids or derivatives thereof, polymers of this type may generally within the scope of the invention be prepared by step-growth polymerization of di-, tri- or higher-functional alcohols or esters thereof with di-, tri- or higher-functional aliphatic or aromatic carboxylic acids or esters thereof. Likewise, also hydroxy acids or anhydrides and halides of polyfunctional carboxylic acids may be used as monomers. The polymerization may involve direct polyesterification or transesterification and may be catalyzed. Use of branched monomers suppresses the crystallinity of the polyester polymers. Mixing of dissimilar monomer units along the chain also suppresses crystallinity. The polymer chains may be ended by monofunctional compounds used to stop the polymerization, control the molecular weight of the biodegradable polymer, and end-cap free hydroxyl and carboxyl groups. Also long chain aliphatic carboxylic acids or aromatic monocarboxylic acids may be comprised in the polymer, whereby the degree of branching has been controlled. Conversely, multifunctional monomers may be a part of the polymer forming the starting points for branching in the polymer.

Examples of preferred polyfunctional carboxylic acids or derivatives thereof are either saturated or unsaturated aliphatic or aromatic and contain 2 to 100 carbon atoms and more preferably 4 to 18 carbon atoms. Specific applicable examples of carboxylic acids, which may be employed as such or as derivatives thereof, include aliphatic polyfunctional carboxylic acids such as oxalic, malonic, citric, succinic, malic, tartaric, fumaric, maleic, glutaric, glutamic, adipic, glucaric, pimelic, suberic, azelaic, sebacic, dodecanedioic acid, etc. and cyclic aliphatic polyfunctional carboxylic acids such as cyclopropane dicarboxylic acid, cyclobutane dicarboxylic acid, cyclohexane dicarboxylic acid, etc. and aromatic polyfunctional carboxylic acids such as terephthalic, isophthalic, phthalic, trimellitic, pyromellitic and naphthalene 1,4-, 2,3-, 2,6-dicarboxylic acids and the like. For the purpose of illustration and not limitation, some examples of carboxylic acid derivatives include hydroxy acids such as 3-hydroxy propionic acid and 6-hydroxycaproic acid and anhydrides, halides or esters of acids, for example dimethyl or diethyl esters, corresponding to the already mentioned acids, which means esters such as dimethyl or diethyl oxalate, malonate, succinate, fumarate, maleate, glutarate, adipate, pimelate, suberate, azelate, sebacate, dodecanedioate, terephthalate, isophthalate, phthalate, etc. Generally speaking, methyl esters are sometimes more preferred than ethyl esters due to the fact that higher boiling alcohols are more difficult to remove than lower boiling alcohols.

Furthermore, examples of usually preferred polyfunctional alcohols contain 2 to 100 carbon atoms as for instance polyglycols and polyglycerols. Specific applicable examples of alcohols, which may be employed as such or as derivatives thereof, include polyols such as ethylene glycol, 1,2-propanediol, 1,3-propanediol, 1,3-butanediol, 1,4-butanediol, 1,6-hexanediol, diethylene glycol, 1,4-cyclohexanediol, 1,4-cyclohexanedimethanol, neopentyl glycol, glycerol, trimethylolpropane, pentaerythritol, sorbitol, mannitol, etc. For the purpose of illustration and not limitation, some examples of alcohol derivatives include triacetin, glycerol palmitate, glycerol sebacate, glycerol adipate, tripropionin, etc.

The preparation of this polyester type typically involves an acid catalyst or a trans-esterification catalyst, and non-limiting examples of those are the metal catalysts such as acetates of manganese, zinc, calcium, cobalt or magnesium, and antimony-(III)oxide, germanium oxide or halide and tetraalkoxygermanium, titanium alkoxide, zinc or aluminum salts.

Examples of chain-stoppers include monohydroxy alcohols or monocarboxylic acids. Specific examples include methanol, ethanol, butanol, hexanol, octanol, etc. and lauryl alcohol, myristyl alcohol, cetyl alcohol, stearyl alcohol, stearic alcohol, etc. and monocarboxylic acids such as acetic, lauric, myristic, palmitic, stearic, arachidic, cerotic, dodecylenic, palmitoleic, oleic, linoleic, linolenic, erucic, benzoic, naphthoic acids and substituted napthoic acids, 1-methyl-2 naphthoic acid and 2-isopropyl-1-naphthoic acid, etc.

In some embodiments of the invention, the gum base comprises wax, and in other embodiments, for example in case of applying certain biodegradable polymers, wax may be avoided.

However, petroleum waxes may aid in the curing of the finished gum made from the gum base as well as improve shelf life and texture. Wax crystal size influences the release of flavor. Those waxes high in iso-alkanes have a smaller crystal size than those waxes high in normal-alkanes, especially those with normal-alkanes of carbon numbers less than 30. The smaller crystal size allows slower release of flavor since there is more hindrance of the flavor's escape from this wax versus a wax having larger crystal sizes. The compatibility of gum bases made using normal-alkanic waxes is less when compared to gum bases made with iso-alkanic waxes.

Petroleum wax (refined paraffin and microcrystalline wax) and paraffin wax is composed of mainly straight-chained normal-alkanes and branched iso-alkanes. The ratio of normal-alkanes to iso-alkanes varies.

The normal-alkanic waxes typically have carbon chain lengths >C-18 but the lengths are not predominantly longer than C-30. The branched and ring structures are located near the end of the chain for those waxes that are predominantly normal-alkanic. The viscosity of normal-alkanic waxes is <10 mm2/s (at 100° C.) and the combined number average molecular weight is <600 g/mole.

The iso-alkanic waxes typically have carbon lengths that are predominantly greater than C-30. The branched chains and ring structures are located randomly along the carbon chain in those waxes that are predominantly iso-alkanic. The viscosity of iso-alkanic waxes is greater than 10 mm2/s (at 100° C.) and the combined number average molekylar weight is >600 g/mole.

Synthetic waxes are produced by means atypical of petroleum wax production and thus are not considered petroleum wax. The synthetic waxes may include waxes containing branched alkanes and copolymerized with monomers such as but not limited to propylene and polyethylene and Fischer Tropsch type waxes. Polyethylene wax is a synthetic wax containing alkane units of varying lengths having attached thereto ethylene monomers.

The natural waxes may include rice bran wax, bees' wax, carnauba wax or candelilla wax. The waxes may be used alone or in any combination.

Softeners may advantageously be added as well in the gum base portion as in the further water-soluble part of the chewing gum substance. As regards the gum base, the selection of softeners has an influence on the softness of the base. Softeners modify the texture, cause the hydrophobic and hydrophilic components of the base to be miscible, and may further plasticize the synthetic elastomers of the gum base. The emulsifiers, which belong to the group of softeners, provide the gum base with water-binding properties, which confer to the gum base a pleasant smooth surface and reduce its adhesive properties.

Softeners suitable for use in the gum base include triglycerides of non-hydrogenated, partially hydrogenated and fully hydrogenated vegetable oils and tallow, cocoa butter and degreased cocoa powder and in addition to these the emulsifiers.

The group of triglycerides include cottonseed, palm, palm kernel, coconut, safflower, rapeseed, sunflower, tallow, soybean, cocoa butter, medium chained triglycerides and the like.

The caproic, caprylic, capric, myristic, lauric and palmitic fatty acids of the triglycerides tend to plasticize the synthetic elastomers more than triglycerides containing predominantly stearic fatty acid

To the group of emulsifiers belong the monoglycerides, diglycerides, acetylated mono and diglycerides, distilled mono- and diglycerides, glycerol monostearate, propylene glycol monostearate, Na-, K-, Mg- and Ca-stearates, glycerol triacetate, fatty acid monoglycerides (e.g. stearic, palmitic, oleic and linoleic acids), lactic acid esters and acetic acid esters of mono- and diglycerides, sugar esters of edible fatty acids also referred to as sucrose polyesters including those disclosed in WO 00/25598, lecithin and hydroxylated lecithin, most of these may contain triglyceride levels less than 2 percent by weight from their manufacturing processing,

The softeners including emulsifiers may be used alone or two or more in combination. Generally, softeners are added to the chewing gum substance to optimize the chewability and mouth feel of the gum.

Softeners also known in the art as plasticizers may constitute about 0.1 to 15% by weight of the chewing gum substance. Further softener examples contemplated by the present invention include glycerine and lecithine. Also, some aqueous sweeteners, e.g. containing sorbitol, hydrogenated starch hydrolysate or corn syrup, may be used as softeners and binding agents in the chewing gum substance.

Fillers used in gum base modify the texture of the gum base and aid in processing. Particle size has an effect on cohesiveness, density and processing characteristics of the gum base and its compounding. The smaller the particle size, the more dense and cohesive the final gum base. Also, by selecting fillers based on their particle size distribution, initial mass compounding may be varied, thus allowing alteration of the compounding characteristics of the initial mass during gum base processing and ultimately the final chew characteristics of gums made from these gum bases. The filler may constitute between about 5 to 60% by weight of the gum base, preferably about 5 to 50% by weight of the gum base.

Fillers suitable for use in the gum base include magnesium and calcium carbonate, ground limestone and silicate types such as magnesium and aluminum silicate, kaolin and clay, aluminum oxide, silicium oxide, talc, as well as titanium oxide, mono-, di- and tricalcium phosphate, sodium sulphate, cellulose polymers such as ethyl, methyl and wood or mixtures thereof.

Talc filler may be used in the gum base and gum of the present invention that may come in contact with or employ acid flavors or provide an acidic environment needed to prevent degradation of an artificial sweetener by reacting with calcium carbonate type fillers. Mean particle size for calcium carbonate and talc fillers typically range from about 0.1 micron to about 15 microns.

The fillers may also include natural organic fibers such as fruit vegetable fibers, grain, rice, cellulose and combinations thereof.

Antioxidants prolong shelf life and storage of gum base and the final chewing gum substance or their respective components including fats and flavor oils. Antioxidants suitable for use in gum base include butylated hydroxyanisole (BHA), butylated hydroxytoluene (BHT), betacarotenes, tocopherols, acidulants such as Vitamin C, propyl gallate, other synthetic and natural types or mixtures thereof. Flavorants and colorants impart characteristics or remove or mask undesired characteristics. They may be applied in the gum base and/or in the mixing of the final chewing gum substance.

Further examples of ingredients, which may be added into the chewing gum substance as a part of the final mixing of water-soluble and water-insoluble parts are given here below. The ingredients are divided into the groups of sweeteners, flavors, surfactants, active ingredients, additives, colors, and material for encapsulating e.g. sweeteners, flavors, or active ingredients.

Suitable bulk sweeteners include both sugar and non-sugar sweetening components. Bulk sweeteners typically constitute from about 5 to about 95% by weight of the chewing gum, more typically about 20 to about 80% by weight such as 30 to 60% by weight of the gum.

Useful sugar sweeteners are saccharide-containing components commonly known in the chewing gum art including, but not limited to, sucrose, dextrose, maltose, dextrins, trehalose, D-tagatose, dried invert sugar, fructose, levulose, galactose, corn syrup solids, and the like, alone or in combination.

Sorbitol can be used as a non-sugar sweetener. Other useful non-sugar sweeteners include, but are not limited to, other sugar alcohols such as mannitol, xylitol, hydrogenated starch hydrolysates, maltitol, isomaltol, erythritol, lactitol and the like, alone or in combination.

High-intensity artificial sweetening agents can also be used alone or in combination with the above sweeteners. Preferred high-intensity sweeteners include, but are not limited to sucralose, aspartame, salts of acesulfame, alitame, saccharin and its salts, cyclamic acid and its salts, glycyrrhizin, dihydrochalcones, thaumatin, monellin, twin sweet stevioside, neotame and the like, alone or in combination. In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coascervation, encapsulation in yeast cells and fiber extrusion may be used to achieve the desired release characteristics. Encapsulation of sweetening agents can also be provided using another chewing gum component such as a resinous compound.

Addition of high-intensity sweeteners may be carried out at the gum base mixing stage or while mixing the final chewing gum substance.

Usage level of the artificial sweetener will vary considerably and will depend on factors such as potency of the sweetener, rate of release, desired sweetness of the product, level and type of flavor used and cost considerations. Thus, the active level of artificial sweetener may vary from about 0.02 to about 30% by weight, preferably 0.02 to about 8% per weight. Typically, high intensity sweeteners may be applied in a small amount in the range of 0.05 to 1% by weight of the chewing gum substance. When carriers used for encapsulation are included, the usage level of the encapsulated sweetener will be proportionately higher. Combinations of sugar and/or non-sugar sweeteners can be used in the chewing gum formulation processed in accordance with the invention. Additionally, the softener may also provide additional sweetness such as aqueous sugar or alditol solutions.

If a low-calorie gum is desired, a low-caloric bulking agent can be used. Examples of low caloric bulking agents include polydextrose, Raftilose, Raftilin, fructooligosaccharides (NutraFlora®), palatinose oligosaccharides; guar gum hydrolysates (e.g. Sun Fiber®) or indigestible dextrins (e.g. Fibersol®). However, other low-calorie bulking agents can be used.

The chewing gum according to the present invention may contain aroma agents and flavoring agents including natural and synthetic flavorings e.g. in the form of natural vegetable components, essential oils, essences, extracts, powders, including acids and other substances capable of affecting the taste profile. Flavoring agents may in some embodiments of the invention be encapsulated with the encapsulation materials defined elsewhere, below, in this text.

Examples of liquid and powdered flavorings include coconut, coffee, chocolate, cocoa, vanilla, grape fruit, orange, lime, menthol, liquorice, caramel aroma, honey aroma, peanut, walnut, cashew, hazelnut, almonds, pineapple, strawberry, raspberry, tropical fruits, cherries, cinnamon, peppermint, wintergreen, spearmint, eucalyptus, and mint, fruit essence such as from apple, pear, peach, strawberry, apricot, raspberry, cherry, pineapple, and plum essence. The essential oils include peppermint, spearmint, menthol, eucalyptus, clove oil, bay oil, anise, thyme, cedar leaf oil, nutmeg, and oils of the fruits mentioned above.

The chewing gum flavor may be a natural flavoring agent, which is freeze-dried, preferably in the form of a powder, slices or pieces or combinations thereof. The particle size may be less than 3 mm, less than 2 mm or more preferred less than 1 mm, calculated as the longest dimension of the particle. The natural flavoring agent may in a form where the particle size is from about 3 μm to 2 mm, such as from 4 μm to 1 mm. Preferred natural flavoring agents include seeds from fruit e.g. from strawberry, blackberry and raspberry.

Various synthetic flavors, such as mixed fruit flavors may also be used in the present chewing gum centers. As indicated above, the aroma agent may be used in quantities smaller than those conventionally used. The aroma agents and/or flavors may be used in the amount from 0.01 to about 30% by weight of the final product depending on the desired intensity of the aroma and/or flavor used. Preferably, the content of aroma/flavor is in the range of 0.2 to 3% by weight of the total chewing gum substance composition.

In an embodiment of the invention, the flavoring agents comprise natural and synthetic flavorings in the form of natural vegetable components, essential oils, essences, extracts, powders, including acids and other substances capable of affecting the taste profile.

Further chewing gum ingredients, which may be included in the chewing gum according to the present invention, include surfactants and/or solubilisers, especially when pharmaceutically or biologically active ingredients are present. As examples of types of surfactants to be used as solubilisers in a chewing gum composition according to the invention, reference is made to H. P. Fiedler, Lexikon der Hilfstoffe für Pharmacie, Kosmetik und Angrenzende Gebiete, pages 63-64 (1981) and the lists of approved food emulsifiers of the individual countries. Anionic, cationic, amphoteric or non-ionic solubilisers can be used. Suitable solubilisers include lecithin, polyoxyethylene stearate, polyoxyethylene sorbitan fatty acid esters, fatty acid salts, mono and diacetyl tartaric acid esters of mono and diglycerides of edible fatty acids, citric acid esters of mono and diglycerides of edible fatty acids, saccharose esters of fatty acids, polyglycerol esters of fatty acids, polyglycerol esters of interesterified castor oil acid (E476), sodium stearoyllatylate, sodium lauryl sulfate and sorbitan esters of fatty acids and polyoxyethylated hydrogenated castor oil (e.g. the product sold under the trade name CREMOPHOR), block copolymers of ethylene oxide and propylene oxide (e.g. products sold under trade names PLURONIC and POLOXAMER), polyoxyethylene fatty alcohol ethers, polyoxyethylene sorbitan fatty acid esters, sorbitan esters of fatty acids and polyoxyethylene steraric acid esters.

Particularly suitable solubilisers are polyoxyethylene stearates, such as for instance polyoxyethylene(8)stearate and polyoxyethylene(40)stearate, the polyoxyethylene sorbitan fatty acid esters sold under the trade name TWEEN, for instance TWEEN 20 (monolaurate), TWEEN 80 (monooleate), TWEEN 40 (monopalmitate), TWEEN 60 (monostearate) or TWEEN 65 (tristearate), mono and diacetyl tartaric acid esters of mono and diglycerides of edible fatty acids, citric acid esters of mono and diglycerides of edible fatty acids, sodium stearoyllatylate, sodium laurylsulfate, polyoxyethylated hydrogenated castor oil, blockcopolymers of ethylene oxide and propyleneoxide and polyoxyethylene fatty alcohol ether. The solubiliser may either be a single compound or a combination of several compounds. In the presence of an active ingredient, the chewing gum may preferably also comprise a carrier known in the art.

Emulsifiers, which are used as softeners may include tallow, hydrogenated tallow, hydrogenated and partially hydrogenated vegetable oils, cocoa butter, glycerol monostearate, glycerol triacetate, lechithin, mono-, di- and triglycerides, acetylated monoglycerides, fatty acids (e.g. stearic, palmitic, oleic and linoleic acids), and combinations thereof.

According to an embodiment of the invention, the filled chewing gum pieces may comprise a pharmaceutically, cosmetically or biologically active substance or ingredient. Examples of such active substances are found in a comprehensive list given e.g. in WO 00/25598, which is incorporated herein by reference. The active ingredients may according to the present invention be added into the inner filling of the chewing gum pieces, or into the coating, or into the chewing gum substance, possibly into the gum base part. The preferred location of the active ingredients may be determined by the desired release rate. In some embodiments of the invention, active ingredient is preferably added both into the chewing gum part and into the filling.

The active agents to be used in connection with the present invention may be any substance desired to be released from the chewing gum. If an accelerated rate of release is desired, corresponding to the effect obtained for the flavor, the primary substances are those with limited water solubility, typically below 10 g/100 ml including substances which are entirely water insoluble. Examples are medicines, dietary supplements, oral compositions, anti-smoking agents, highly potent sweeteners, pH adjusting agents, etc.

Further examples of active ingredients include paracetamol, benzocaine, cinnarizine, menthol, carvone, caffeine, chlorhexidine-di-acetate, cyclizine hydrochloride, 1,8-cineol, nandrolone, miconazole, mystatine, aspartame, sodium fluoride, nicotine, saccharin, cetylpyridinium chloride, other quaternary ammonium compounds, vitamin E, vitamin A, vitamin D, glibenclamide or derivatives thereof, progesterone, acetylsalicylic acid, dimenhydrinate, cyclizine, metronidazole, sodium hydrogen-carbonate, the active components from ginkgo, the active components from propolis, the active components from ginseng, methadone, oil of peppermint, salicylic amide, hydrocortisone or astemizole.

Examples of active agents in the form of dietary supplements are for instance salts and compounds having the nutritive effect of vitamin B2 (riboflavin), B12, folinic acid, niacine, biotine, poorly soluble glycerophosphates, amino acids, the vitamins A, D, E and K, minerals in the form of salts, complexes and compounds containing calcium, phosphorus, magnesium, iron, zinc, copper, iodine, manganese, chromium, selenium, molybdenum, potassium, sodium or cobalt.

Furthermore, reference is made to lists of nutritients accepted by the authorities in different countries such as for instance US code of Federal Regulations, Title 21, Section 182.5013.182 5997 and 182.8013-182.8997.

Examples of active agents in the form of compounds for the care or treatment of the oral cavity and the teeth are for instance bound hydrogen peroxide and compounds capable of releasing urea during chewing.

Examples of active agents in the form of antiseptics are for instance salts and compounds of guanidine and biguanidine (for instance chlorhexidine diacetate) and the following types of substances with limited water-solubility: quaternary ammonium compounds (for instance ceramine, chloroxylenol, crystal violet, chloramine), aldehydes (for instance paraformaldehyde), compounds of dequaline, polynoxyline, phenols (for instance thymol, para chlorophenol, cresol) hexachlorophene, salicylic anilide compounds, triclosan, halogenes (iodine, iodophores, chloroamine, dichlorocyanuric acid salts), alcools (3,4 dichlorobenzyl alcohol, benzyl alcohol, phenoxyethanol, phenylethanol), cf. furthermore Martindale, The Extra Pharmacopoeia, 28th edition, page 547-578; metal salts, complexes and compounds with limited water-solubility, such as aluminum salts, (for instance aluminum potassium sulfate AIK (S04) 2, 12H₂0) and furthermore salts, complexes and compounds of boron, barium, strontium, iron, calcium, zinc, (zinc acetate, zinc chloride, zinc gluconate), copper (copper chloride, copper sulfate), lead, silver, magnesium, sodium, potassium, lithium, molybdenum, vanadium should be included; other compositions for the care of mouth and teeth: for instance; salts, complexes and compounds containing fluorine (such as sodium fluoride, sodiummonofluorophosphate, aminofluorides, stannous fluoride), phosphates, carbonates and selenium.

Cf. furthermore J. Dent. Res. Vol. 28 No. 2, page 160-171,1949, wherein a wide range of tested compounds are mentioned.

Examples of active agents in the form of agents adjusting the pH in the oral cavity include for instance: acceptable acids, such as adipinic acid, succinic acid, fumaric acid, or salts thereof or salts of citric acid, tartaric acid, malic acid, acetic acid, lactic acid, phosphoric acid and glutaric acid and acceptable bases, such as carbonates, hydrogen carbonates, phosphates, sulfates or oxides of sodium, potassium, ammonium, magnesium or calcium, especially magnesium and calcium.

Examples of active agents in the form of anti-smoking agents include for instance: nicotine, tobacco powder or silver salts, for instance silver acetate, silver carbonate and silver nitrate.

Further examples of active agents are medicines of any type.

Examples of active agents in the form of medicines include caffeine, salicylic acid, salicylic amide and related substances (acetylsalicylic acid, choline salicylate, magnesium salicylate, sodium salicylate), paracetamol, salts of pentazocine (pentazocine hydrochloride and pentazocinelactate), buprenorphine hydrochloride, codeine hydrochloride and codeine phosphate, morphine and morphine salts (hydrochloride, sulfate, tartrate), methadone hydrochloride, ketobemidone and salts of ketobemidone (hydrochloride), beta-blockers, (propranolol), calcium antagonists, verapamil hydrochloride, nifedinpine as well as suitable substances and salts thereof mentioned in Pharm. Int., Nov. 85, pages 267-271, Barney H. Hunter and Robert L. Talbert, nitroglycerine, erythrityl tetranitrate, strychnine and salts thereof, lidocaine, tetracaine hydrochloride, etorphine hydrochloride, atropine, insulin, enzymes (for instance papain, trypsin, amyloglucosidase. glucoseoxidase, streptokinase, streptodornase, dextranase, alpha amylase), polypeptides (oxytocin, gonadorelin, (LH. RH), desmopressin acetate (DDAVP), isoxsuprine hydrochloride, ergotamine compounds, chloroquine (phosphate, sulfate), isosorbide, demoxytocin, heparin.

Other active ingredients include beta-lupeol, Letigen, Sildenafil citrate and derivatives thereof.

Dental products include Carbami, CPP Caseine Phospho Peptide; Chlorhexidine, Chlorhexidine di acetate, Chlorhexidine Chloride, Chlorhexidine di gluconate, Hexetedine, Strontium chloride, Potassium Chloride, Sodium bicarbonate, Sodium carbonate, Fluor containing ingredients, Fluorides, Sodium fluoride, Aluminum fluoride, Ammonium fluoride, Calcium fluoride, Stannous fluoride, Other fluor containing ingredients Ammonium fluorosilicate, Potassium fluorosilicate, Sodium fluorosilicate, Ammonium monofluorphosphate, Calcium monofluorphosphate, Potassium monofluorphosphate, Sodium monofluorphosphate, Octadecentyl Ammonium fluoride, Stearyl Trihydroxyethyl Propylenediamine Dihydrofluoride, Vitamins include A, B1, B2, B6, B12, Folin acid, niacin, Pantothensyre, biotine, C, D, E, K.

Minerals include Calcium, phosphor, magnesium, iron, Zink, Cupper, lod, Mangan, Crom, Selene, Molybden. Other active ingredients include: Q10@, enzymes. Natural drugs including Ginkgo Biloba, ginger, and fish oil. The invention also relates to use of migraine drugs such as Serotonin antagonists: Sumatriptan, Zolmitriptan, Naratriptan, Rizatriptan, Eletriptan; nausea drugs such as Cyclizin, Cinnarizin, Dimenhydramin, Difenhydrinat; hay fever drugs such as Cetrizin, Loratidin, pain relief drugs such as Buprenorfin, Tramadol, oral disease drugs such as Miconazol, Amphotericin B, Triamcinolonaceton; and the drugs Cisaprid, Domperidon, Metoclopramid.

Active ingredients may comprise the below-mentioned compounds or derivates thereof but are not limited thereto: Acetaminophen, Acetylsalicylic acid

Buprenorphine Bromhexin Celcoxib Codeine, Diphenhydramin, Diclofenac, Etoricoxib, Ibuprofen, Indometacin, Ketoprofen, Lumiracoxib, Morphine, Naproxen, Oxycodon, Parecoxib, Piroxicam, Pseudoefedrin, Rofecoxib, Tenoxicam, Tramadol, Valdecoxib, Calciumcarbonat, Magaldrate, Disulfiram, Bupropion, Nicotine, Azithromycin, Clarithromycin, Clotrimazole, Erythromycin, Tetracycline, Granisetron, Ondansetron, Prometazin, Tropisetron, Brompheniramine, Ceterizin, leco-Ceterizin, Chlorcyclizine, Chlorpheniramin, Chlorpheniramin, Difenhydramine, Doxylamine, Fenofenadin, Guaifenesin, Loratidin, des-Loratidin, Phenyltoloxamine, Promethazin, Pyridamine, Terfenadin, Troxerutin, Methyldopa, Methylphenidate, Benzalcon. Chloride, Benzeth. Chloride, Cetylpyrid. Chloride, Chlorhexidine, Ecabet-sodium, Haloperidol, Allopurinol, Colchinine, Theophylline, Propanolol, Prednisolone, Prednisone, Fluoride, Urea, Miconazole, Actot, Glibenclamide, Glipizide, Metformin, Miglitol, Repaglinide, Rosiglitazone, Apomorfin, Clalis, Sildenafil, Vardenafil, Diphenoxylate, Simethicone, Cimetidine, Famotidine, Ranitidine, Ratinidine, cetrizin, Loratadine, Aspirin, Benzocaine, Dextrometorphan, Ephedrine, Phenylpropanolamine, Pseudoephedrine, Cisapride, Domperidone, Metoclopramide, Acyclovir, Dioctylsulfosucc., Phenolphtalein, Almotriptan, Eletriptan, Ergotamine, Migea, Naratriptan, Rizatriptan, Sumatriptan, Zolmitriptan, Aluminum salts, Calcium salts, Ferro salts, Silver salts, Zinc-salts, Amphotericin B, Chlorhexidine, Miconazole, Triamcinolonacetonid, Melatonine, Phenobarbitol, Caffeine, Benzodiazepiner, Hydroxyzine, Meprobamate, Phenothiazine, Buclizine, Brometazine, Cinnarizine, Cyclizine, Difenhydramine, Dimenhydrinate, Buflomedil, Amphetamine, Caffeine, Ephedrine, Orlistat, Phenylephedrine, Phenylpropanolamin, Pseudoephedrine, Sibutramin, Ketoconazole, Nitroglycerin, Nystatin, Progesterone, Testosterone, Vitamin B12, Vitamin C, Vitamin A, Vitamin D, Vitamin E, Pilocarpin, Aluminumaminoacetat, Cimetidine, Esomeprazole, Famotidine, Lansoprazole, Magnesiumoxide, Nizatide and or Ratinidine.

In one embodiment of the invention, the flavor may be used as taste masking in chewing gum comprising active ingredients, which by themselves has undesired taste or which alter the taste of the formulation.

The chewing gum substance may optionally contain usual additives, such as binding agents, acidulants, fillers, coloring agents, preservatives, and antioxidants, for instance butylated hydroxytoluene (BHT), butyl hydroxyanisol (BHA), propylgallate and tocopherols.

Colorants and whiteners may include FD & C-type dyes and lakes, fruit and vegetable extracts, titanium dioxide, and combinations thereof.

Materials to be used for the above-mentioned encapsulation methods for e.g. sweeteners and flavors might e.g. include Gelatine, Wheat protein, Soya protein, Sodium caseinate, Caseine, Gum arabic, Mod. starch, Hydrolyzed starches (maltodextrines), Alginates, Pectin, Carregeenan, Xanthan gum, Locus bean gum, Chitosan, Bees wax, Candelilla wax, Carnauba wax, Hydrogenated vegetable oils, Zein and/or Sucrose.

Manufacturing of the chewing gum substance is usually commenced by the preparation of gum base. Gum bases may be prepared by adding an amount of the elastomer, elastomer plasticizer and filler, and on occasion a vinyl polymer, to a heated (10° C.-120° C.) e.g. sigma blade mixer with a front to rear speed ratio of from about 1.2:1 to about 2:1, the higher ratio typically being used for a gum base, which requires more rigorous compounding of its elastomers.

The initial amounts of ingredients comprising the initial mass may be determined by the working capacity of the mixing kettle in order to attain a proper consistency and by the degree of compounding desired to break down the elastomer and increase chain branching. The higher the level of filler at the start or selection of a filler having a certain particle size distribution, the higher the degree of compounding and thus more of the elastomeric chain cross linking is broken, causing more branching of the elastomer thus lower viscosity gum bases and thus softer final gum base and gum made from such a gum base. The longer the time of compounding, the use of lower molecular weight or softening point gum base ingredients, the lower the viscosity and firmness of the final gum base.

Compounding typically begins to be effective once the ingredients have massed together. Anywhere from 15 minutes to 90 minutes may be the length of compounding time.

Preferably, the time of compounding is from 20 minutes to about 60 minutes. The amount of added elastomer plasticizer depends on the level of elastomer and filler present. If too much elastomer plasticizer is added, the initial mass becomes over plasticized and not homogeneous.

After the initial ingredients have massed homogeneously and compounded for the time desired, the balance of the gum base ingredients are added in a sequential manner until a completely homogeneous molten mass is attained. Typically, any remainder of elastomer, elastomer plasticizer, vinyl polymer and filler, are added within 60 minutes after the initial compounding time. The filler and the elastomer plasticizer would typically be individually weighed and added in portions during this time. The optional waxes and the softeners are typically added after the elastomer and elastomer plasticizers and during the next 60 minutes. Then the mass is allowed to become homogeneous before dumping.

Typical gum base processing times may vary from about one to about three hours, preferably from about 1½ to 2½ hours, depending on the formulation. The final mass temperature when dumped may be between 70° C. and 130° C., and preferably between 100° C. and 120° C. It should be noted, that the time for mixing may be shorter and the temperature considerably lower when manufacturing the gum base and chewing gum substance on the basis of biodegradable polymers. The temperature applied when mixing biodegradable polymers may typically be within the range of 40 to 80° C., at which temperatures degradation during the manufacturing process may be avoided.

The completed molten mass is emptied from the mixing kettle into coated or lined pans, extruded or cast into any desirable shape and allowed to cool and solidify. Those skilled in the art will recognize that many variations of the above-described procedure may be followed. Thus, the chewing gum including all so-called gum base components and also the further chewing gum ingredients may be extruded in one single process. Furthermore, the manufacturing of chewing gum substance may be directly continued, without any considerable storage time, in an extruder forming the filled chewing gum rope, from which the filled chewing gum pieces of the present invention are obtained.

The chewing gum rope may be filled with any of the materials known in the art as suitable for center-filled chewing gum. Generally, the filling may at normal storage and use temperature have the consistency of a liquid, a paste, or a powder. Usual components in the inner filling applied according to the present invention may be selected from bulk sweeteners, high intensity sweeteners, flavors, active ingredients, and mixtures thereof. Specific examples of such components are given above; these groups of ingredients mentioned above are applicable in the filling as well as in the chewing gum substance. It is advantageous according to the invention that an immediate release may be obtained from ingredients applied in the filling, when the filled chewing gum pieces are chewed. This immediate release may advantageously be combined with a slower release obtained from ingredients, which have been mixed into the chewing gum substance.

Some of the bulk ingredients, which are frequently applied in filling material for filled chewing gum with liquid- or paste-like filling, include sorbitol, glycerin, maltitolsyrup, hydrogenated starch hydrolysate, and lecithin. Likewise, a powdered filling may among many other examples comprise powdered sweeteners, and powdered flavors such as e.g. freeze-dried fruit powder or herbs, vegetables, liquorice, ammonium chloride, and candy.

It has been found that it is actually possible to extrude and form filled chewing gum pieces, when anti-sticking agent is applied onto the surface of the chewing gum substance rope during the manufacturing process. Hereby it has been found that a chewing gum substance having a texture suitable for extruding to a small wall thickness may be applied, because problems with stickiness of the relatively soft chewing gum texture may be counteracted by the application of anti-sticking agent. Both sticking to machinery and individual chewing gum pieces sticking to each other may hereby be prevented according to the invention.

Examples of suitable anti-sticking agents include calcium hydroxide, talc, D-mannitol, silicon dioxide, sucrose ester, calcium stearate, zink stearate, magnesium stearate, and other metallic stearates, polyoxyethylene monostearates, silicates, polyethylene glycols, silicate dioxide, fumed silica, stearic acid, calcium carbonate, etc. and mixtures thereof.

According to the present invention, the filled chewing gum pieces are provided with an outer coating covering the anti-sticking agent, providing a pleasant taste and protecting the filled chewing gum piece.

One advantage of providing the filled chewing gum pieces with an outer coating according to the present invention is that an advantageous protective effect may be obtained. Thereby the chewing gum substance is protected from drying up, and hence protected from cracking of the chewing gum substance with leaking as a result. This protective effect is especially important, as the chewing gum substance applied according to the present invention is sugarless or sugar free. Overall, the coating may provide the chewing gum pieces of the present invention with an increased storability.

Various coating materials may be applied, and the coating types may be selected from hard coatings, soft coatings, film coatings, or coatings of any type that is known in the art, or a combination of such coatings. The coating may typically constitute 10 to 50 percent by weight of a coated filled chewing gum piece.

Hard coatings include sugar coatings and sugar free (or sugarless) coatings and combinations thereof. It is an advantage to apply a hard coating, when a sweet, crunchy layer is desired as the initial sensation by the consumer of the filled chewing gum piece. Also, a hard coating has the best protective effects, which are typically desired according to the present invention. In a typical process of providing the chewing gum pieces with a protective sugar coating, the gum centers are successively treated in suitable coating equipment with aqueous solutions of crystallisable sugar such as sucrose or dextrose, which, depending on the stage of coating reached, may contain other functional ingredients, e.g. fillers, colors, active ingredients etc.

In the present invention sugarless or sugar free coating is preferred, and the coating agent may e.g. be a polyol including as examples sorbitol, maltitol, mannitol, xylitol, erythritol, lactitol and isomalt or e.g. a mono- di-saccharide including as example trehalose.

Alternatively a sugar free soft coating may be applied, e.g. comprising a syrup of a polyol or a mono- di-saccharide, including as examples sorbitol, maltitol, mannitol, xylitol, erythritol, lactitol, isomalt and trehalose.

Furthermore, a film coating may be applied, which comprises film-forming agents such as cellulose derivative, modified starch, dextrin, gelatine, zein, shellec, gum arabic, vegetable gum, synthetic polymer, etc. or a combination thereof.

A coating according to the present invention may typically comprise at least a sweetening polyol, a high intensity sweetener, and a flavor.

According to an embodiment of the invention, the coating comprises sugar such as glucose, sucrose, dextrose, etc.

In general, it may in certain embodiments of the invention be preferred to include at least one additive component in the coating material. Examples of such additive component include binding agents, moisture-absorbing components, film-forming agents, dispersing agents, anti-sticking components, bulking agents, flavoring agents, coloring agents, active ingredients such as pharmaceutically or cosmetically active substances, lipid components, wax components, and acids.

A coated filled chewing gum piece according to the invention may have any form, shape or dimension that permits the chewing gum piece to be coated using any conventional coating process.

The outer appearance of the final chewing gum piece may for example be a pellet, a cushion-shaped pellet, a tablet, a chunk, a pastille, a pill, a ball, and a sphere, and typically the weight of the filled chewing gum may for example be within the range of 0.5 to 15 grams, preferably about 1 to 5 grams.

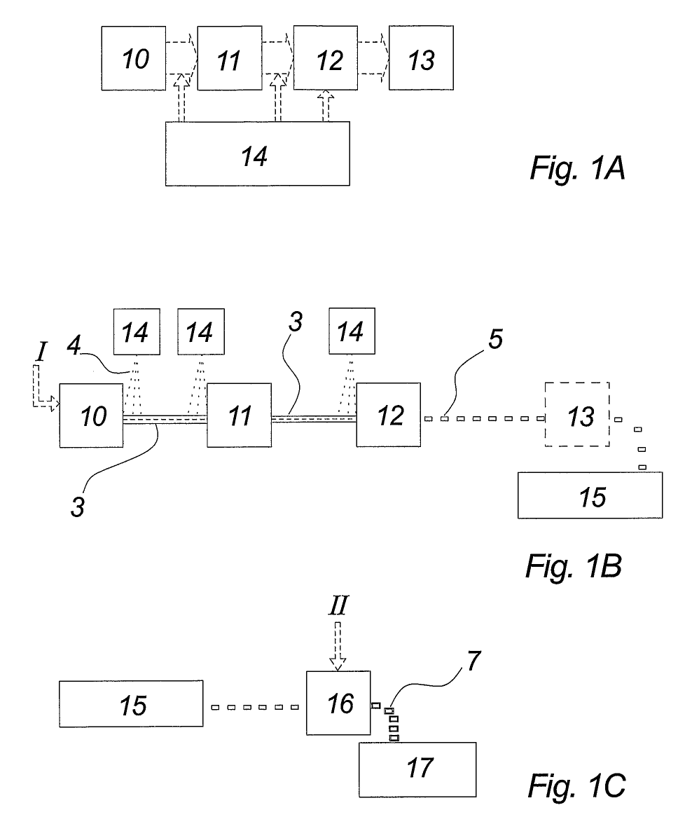

Turning now to FIGS. 1A-1C, the illustrations show schematic views of the elements in the continuous process, which may be used to prepare the filled chewing gum pieces according to an embodiment of the present invention.

The illustrated chewing gum manufacturing process involves an extruder 10 feeding a rope sizer 11. The rope sizer 11 is again feeding a tablet forming arrangement 12, which again may, optionally, feed a cooling arrangement 13. Moreover, the arrangement comprises a conditioning arrangement 14 for anti-sticking agent. An intermediate arrangement 15 connects the past manufacturing process and the following coating process involving a coater 16. Finally, the manufacturing process is ended with a storage or packaging arrangement 17.

Initial feeding materials I, comprising chewing gum substance and inner filling material, are introduced into the extruder as indicated by the I-arrow. Anti-sticking agent 4 is applied to the extruded filled chewing gum rope 3 during the manufacturing process by way of the conditioning arrangement 14. The anti-sticking agent 4 may be applied, while the extruded rope 3 is moving through the rope sizer 11 or the tablet forming arrangement 12, or the agent 4 may be applied just before or after the different arrangements. For example FIGS. 1A and 1B indicate different application sites for the anti-sticking agent added before or into the tablet forming arrangement 12. In the tablet forming arrangement 12, individual chewing gum pieces 5 are formed. The chewing gum pieces 5 are uncoated, except from the applied anti-sticking agent. Coating material II is introduced into the coater 16, and the chewing gum pieces 5 are coated to form the final coated chewing gum pieces 7, which are stored until they are transferred to a packaging process, or they are packed immediately.

Initially, chewing gum substance is mixed, either fresh or as a re-mix of earlier prepared chewing gum pellets, for example in a Z-blade mixer. Alternatively, the mixing may be carried out directly in a continuous process, that is, the chewing gum substance may be mixed in an extruder. During mixing, the temperature is raised, and a coherent mass of chewing gum substance is obtained.

If the chewing gum substance is mixed in a separate mixer in a batch process, it is transferred to the extruder 10, when the desired texture is achieved. If the chewing gum substance alternatively is made in a continuous process, this mixing may be performed by the illustrated extruder 10 in a known manner.

The extrusion of a chewing gum rope 3 may be carried out at a temperature in the range of 30-90° C., for example the extruder 10 may be heated to a temperature of 35-50° C., and the extruder 10 extrudes a rope of chewing gum substance, while injecting an inner filling material. The material introduced as inner filling may preferably be a liquid or a paste and/or may comprise powder, crunchy particles, or other insoluble matters. The filling may typically comprise at least a sweetener and a flavor, and when cooled to normal storage temperature such as 20° C., the consistency of the filling material may be fluid-like, paste-like, as well as solid-like.

In an embodiment of the invention, it may be advantageous that the chewing gum substance, which is supplied into the extruder, has been waiting, or resting in about at least 15 minutes since mixing or re-mixing before it is extruded by the extruder 10.

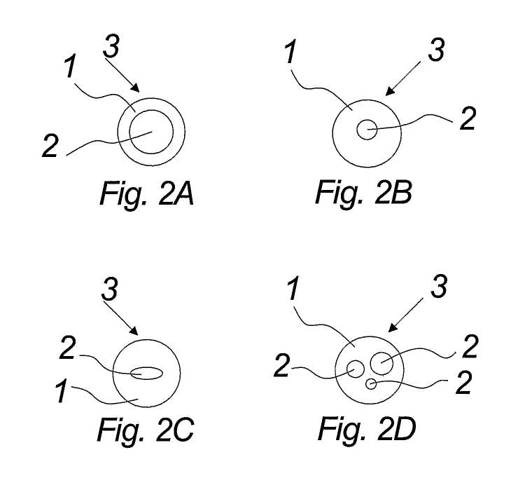

Cross-sections of different examples of extruded, filled chewing gum ropes 3 are shown in FIG. 2A-2D. Chewing gum substance 1 encapsulates or encloses an inner filling material 2, which may appear within the rope in different shapes, either in the center or at a distance from the center. The inner filling 2 may for instance appear as a roughly circular or oval shape, and may as illustrated in FIG. 2D be extruded as multiple strings of filling material 2 within the chewing gum rope J.

Immediately or shortly after the extrusion, the rope is subjected to application of an anti-sticking agent 4 by the conditioning arrangement 14. The anti-sticking agent 4, e.g. talc may for example be sprinkled or dusted onto the rope surface. If required, anti-sticking agent 4 may be applied again directly before a rope-sizing arrangement 11 or in the rope-sizing arrangement 11, wherein rope sizing wheels may continuously reduce the diameter of the rope 3 to the desired diameter in order to form pieces of a certain desired size. It was found that the chewing gum rope 3 could be reduced in size to a relatively small diameter and wall thickness (for example, a wall thickness of 2 mm may be obtained) surrounding the inner filling, when anti-sticking agent was applied to prevent stickiness.

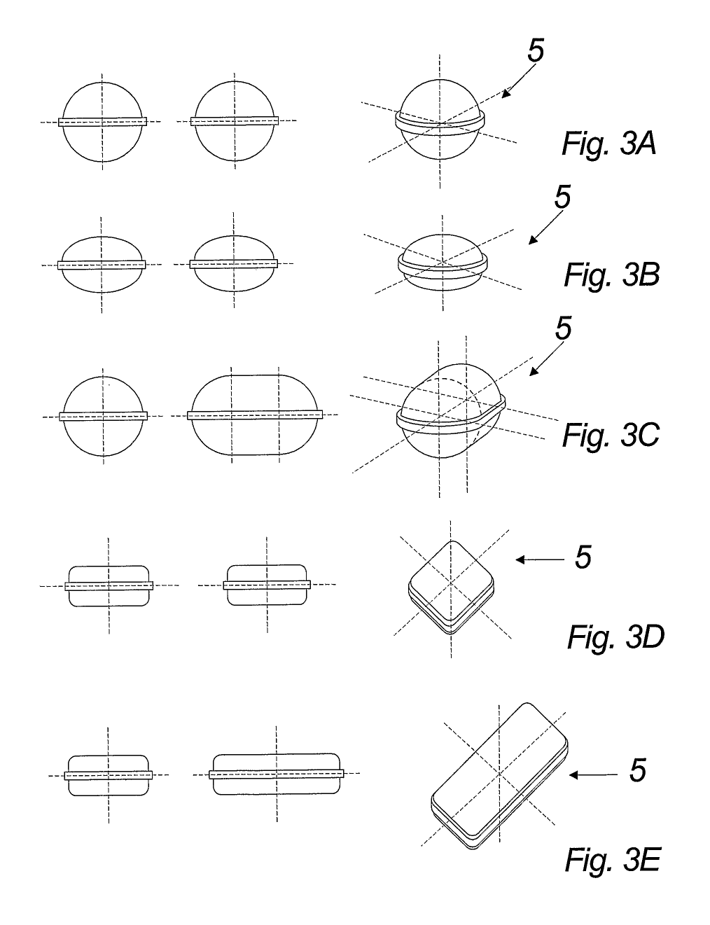

Subsequent to rope sizing, the filled chewing gum rope 3 is fed into a tablet-forming arrangement 12, wherein individual chewing gum pieces 5 are cut out and formed from the rope. By use of different shapes of e.g. die-cutting tool, different kinds of tablet forms may be produced. Few of many examples hereof are indicated in FIG. 3A-3H, wherein the pieces are illustrated in uncoated form, and hence marks, such as a belt around the middle of the chewing gum piece, originating from the tablet forming arrangement 12 may be visible. The pieces indicated in FIG. 3A-3H may have lengths of for example 10 to 50 mm in their longest directions, each of the pieces 3A-3H considered individually.

Finally, the finished uncoated tablets 5 are cooled, optionally by cooling means 13, either actively, e.g. by a cooling tunnel, or passively as a result of the surrounding temperature in the production area.

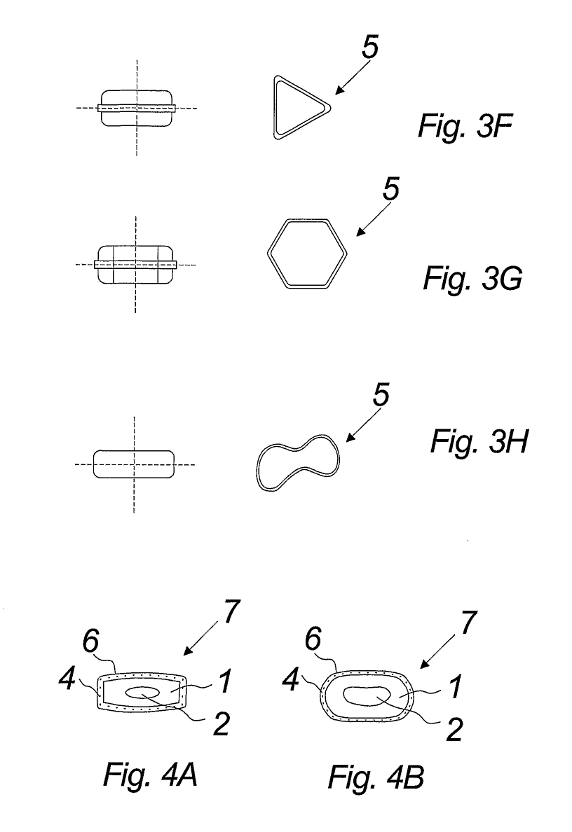

To prepare the tablets with a pleasantly sweet or flavored surface, the chewing gum pieces are coated to form the finished coated chewing gum pieces 7, which are also illustrated in FIG. 4A-4B. FIG. 4A-4B illustrates that the filled chewing gum tablets of the present invention comprises a chewing gum substance 1 surrounding an inner filling 2 and being provided with an anti-sticking agent 4 and coated by a coating 6. Since, the anti-sticking agent 4, which is applied on the uncoated tablets during manufacturing, may cause a very undesired mouth feel when chewing directly on an anti-sticking agent 4 such as talc, it is important to cover the uncoated tablets with a coating layer 6. The coating layer serves to provide a nice initial taste and sensation in the mouth. Often, the coating layer may be a hard crunchy coating, but other types of coating may be applied as well. Sometimes, a soft- or film-coat may be desired, or alternatively the coating may comprise a kind of candy such as sweet, toffee, liquorice, or chocolate.

The process of extruding, rope-sizing and piece forming may in an embodiment of the invention be carried out at temperatures in the range of 30-100° C., preferably in the range of 35-75° C., and typically at about 45-55° C. Experiments have shown, that the elevated temperature caused the chewing gum substance to acquire improved shaping, sticking, and stretching ability. It was found during the experiments that the consequence of lowering the temperature too much during the process of extruding, cutting and forming the filled tablets or pieces were a considerable increase in problems relating to elongation and flexibility of the chewing gum substance. Even small decreases in temperature below the optimal shaping temperature of individual chewing gum formulations resulted in leakage problems.

Thus, the capabilities of stretching and shaping were important in order to extrude the chewing gum rope and shape it to form tablets. Likewise, the sticky characteristics were essential to facilitate a quick and effective closing at the end of each piece of chewing gum rope, which were cut off and shaped in the piece forming mechanism. However, the stickiness, although being necessary for closing the pieces, was also presenting a large problem, as the chewing gum substance was sticking to the machines. The problem was experienced both in the extruder, the rope-sizing mechanism, and the tablet forming mechanism. Experiments showed, that the problem could be solved by application of anti-sticking agent.

The following examples of the invention are non-limiting and only provided for the purpose of explanation.

### EXAMPLE 1

### Gum Bases

Three different gum bases were prepared according to the formulations in table 1:

TABLE 1
Examples of different gum base compositions.

| | Gum base no. | | |
|---|---|---|---|
| Components | 501 | 502 | 503 |
| Elastomer | 19 | 14.5 | 11.4 |
| PVA | 19.9 | 20.2 | 39.2 |
| Natural resins | 20 | 20 | 15.5 |
| Filler | 17.5 | 18.9 | 17.4 |
| Softeners | 23.6 | 26.4 | 16.5 |

Gum base no. 501 is relatively soft, and gum base no. 502 is relatively hard.

Gum base no. 503 may be referred to as a bubble gum base, as the features of this gum base are well suited for obtaining a bubble gum. Gum base no. 503 has marked elongation ability, which is mainly based on a high content of high molecular weight PVA.

It should further be noted, that softeners and fillers may alternatively be added to the chewing gum as a part of the preparation of chewing gum substance.

The gum base was produced by mixing the ingredients at a temperature of approximately 120° C., and thereupon cooling the mixture and transferring the gum base mixture to the chewing gum mixer. It should be noted, that gum base and chewing gum mixing may alternatively be carried out uninterrupted in one step.

### EXAMPLE 2

### Chewing Gum Substances

Different chewing gum substances were mixed according to the formulations given in table 2.

TABLE 2
Examples of different chewing gum substance compositions.

| | Chew. gum sub. | | | | | |
|---|---|---|---|---|---|---|
| Components | 1001 | 1002 | 1003 | 1004 | 1005 | 1006 |
| Gum base no. 501 (soft) | 20 | 40 | 5 | | 35 | 33 |
| Gum base no. 502 (hard) | 20 | | | 35 | | |
| Gum base no. 503 (bubble) | | | 35 | 5 | 5 | 7 |
| Bulk sweetener | 48.7 | 48 | 47.8 | 48 | 47.7 | 48.4 |
| Maltitol syrup | 5 | 5.5 | 5 | 5 | 6 | 4 |
| Emulsifier | 0.3 | 0.2 | 0.2 | 0.3 | 0.3 | 0.3 |
| High-intensity sweeteners | | 0.3 | | 0.2 | | 0.3 |
| Peppermint flavorings | | 3 | | | 3 | |
| Lemon flavorings | 3 | | | 3.5 | | |
| Strawberry flavorings | | | 4 | | | 4 |
| Active ingredients | 3 | 3 | 3 | 3 | 3 | 3 |

In the chewing gum substance examples 1001-1006, the percentage of gum base is kept at 40% by weight, making the different chewing gum formulations comparable. However, various further examples could be prepared with higher or lower gum base content, typically 30-50% gum base. Obviously, the appropriate percentage of gum base may be lower, in case softeners and fillers are added directly into the chewing gum formulation, and hence are not part of the gum base percentage.

The chewing gum ingredients were mixed at a temperature of about 50° C., and the chewing gum substance was supplied into an extruder. It is noted, that an alternative, but equally applicable, procedure may be to mix the chewing gum substance continuously by means of the extruder.

### EXAMPLE 3

### Manufacturing Filled Chewing Gum Pieces

Filled chewing gum pieces were manufactured by a continuous process, which involved the following steps: Extruding a chewing gum rope with an inner filling, sizing the rope to a diameter of for example about 16-19 mm, and supplying the rope continuously into a piece forming machine, in which pieces of filled chewing gum rope were shaped and cut into pieces. Different sectional views of an extruded, filled rope according to the invention are illustrated in FIG. 2A-2D, wherein 1 is chewing gum substance and 2 is inner filling. The figures illustrate that the inner filling material may be located in different positions in the rope, that are not necessarily exactly in the geometrical center of the rope.

The process was carried out at a temperature of about 45-55° C., and anti-sticking agent was applied immediately after the extruder, before the rope sizer, and before the piece forming and cutting mechanism.

The chewing gum pieces, e.g. such as those indicated in FIG. 3A-3H were produced with inner filling and with dimensions in the vicinity of the example-dimensions given in table 3. Both lens-shaped (round) and oval-shaped chewing gum pieces were produced. By way of the form of the chewing gum piece forming mechanism, the chewing gum pieces were provided with flat portions, which made them easier to handle during the following process of sorting and packaging.

The material used as inner filling was maltitolsyrup comprising small amounts of flavoring agent and active ingredients, and examples of filling percentages are given in table 3.

TABLE 3
Dimension-, weight- and filling %-examples of some
of the filled chewing gum pieces produced.

| | | | Thick- | Tablet-weight | Weight | Filling % of |
|---|---|---|---|---|---|---|
| | Length | Width | ness | [g] | [g] of | uncoated/ |
| Tablet-form | [mm] | [mm] | [mm] | uncoated/coated | filling | coated tablet |
| Coated lens | 18 | 18 | 8 | 2.0/2.3 | 0.3 | 15/13 |
| Uncoated oval | 24 | 16 | 12 | 3.8 | 0.4 | 11 |
| Coated oval | 26 | 18 | 14 | 5.0 | 0.5 | 10 |

### EXAMPLE 4

### Evaluation of Chewing Gum Substances

During and after manufacturing of filled chewing gum pieces, the different chewing gum substances were compared. The texture of the different chewing gum substances were evaluated both with regard to process-ability and the final chew feel. See table 4:

TABLE 4
Evaluation with regard to process-ability and
with regard to chew feel of the chewing gum
substance in the final chewing gum pieces.

| Chew. | | |
|---|---|---|
| Gum. sub. | Process-ability | Chew feel |
| 1001 | Moderately acceptable. The stretching | Very firm |
| | ability of the chewing gum substance was | texture |
| | insufficient. Thus, cracking and breaking of | |
| | the rope was generally a problem. | |
| 1002 | Acceptable. It was possible to extrude filled | Acceptable |
| | chewing gum rope and form the tablets of | texture |
| | example 3. However, the extruded rope had | |
| | an undesirable tendency to crack and/or | |
| | break. The chewing gum substance seemed | |
| | too dry. | |
| 1003 | Acceptable. The chewing gum substance | Nice and soft |
| | was very pliant and flexible. Advantageous | texture |
| | elongability was observed as practically no | |
| | tendency of breaking was observed. Thus, | |
| | extrusion and forming into tablets was | |
| | accomplished rather smoothly. However, it | |
| | appeared that the high degree of flexibility | |
| | of the material caused the obtained chewing | |
| | gum pieces to change their shape after the | |
| | forming process was ended. | |
| 1004 | Moderately acceptable. Insufficient | A bit too hard |
| | stretching ability, and generally many | texture |
| | problems with cracking and breaking of the | |
| | rope. | |
| 1005 | Fairly good. The chewing gum substance | Nice texture |
| | was quite stretchable and kept its shape | |
| | after ending of the forming process. | |
| 1006 | Fairly good. The chewing gum substance | Nice texture |
| | was quite stretchable and kept its shape | |
| | after ending of the forming process. | |

### EXAMPLE 5

### Coating of Filled Chewing Gum Tablets

The filled chewing gum pieces were coated by a typical hard coating process, as it will be described in details in the following.

A syrup containing water-solution of crystallisable polyol, high intensity sweetener and flavor were applied onto the chewing gum pieces and the water was evaporated off by blowing with warm, dry air. This cycle was repeated several times, typically 10 to 80 times, in order to reach the size required, which may be a desired increase in weight of the products, as considered at the end of the coating operation by comparison with the beginning, and in relation to the final weight of the coated products. Alternatively, the coating layers could be applied by use of a continuous coating process, and hereby the required size may also be obtained.

In accordance with the present invention, the coating layer constitutes for example about 0 to 75% by weight of the finished confectionery product, such as about 10 to 60% by weight, including about 15 to 50% by weight.

FIG. 3A-3H illustrates different shape of the chewing gum pieces according to the invention prior to coating. It is noted that the subsequent coating typically may tend to smooth the structural characteristics, especially when dealing with hard coating.

It is noted that the shapes of the chewing gum pieces illustrated in FIG. 3B-3H are particularly preferred according to the invention due to the fact that such tablets facilitates an effective handling subsequent to forming and already prior to coating as the tablets, due the at least one substantially flat portion of the tablet is relatively easy to fix even when transported from one location to another.

According the invention, an advantageous embodiment may be obtained, when the chewing gum piece comprises a flat (flattened) portion. Specifically, an advantage appears during the sorting and packing stages of the production process. In these stages, the concurrent handling of a lot of pieces has according to the present invention been found to be more convenient, when the pieces are provided with at least one flat portion. The existence of a flat portion of the tablets results in that the individual tablets may be oriented with respect to each other, thereby facilitating an evaluation and sorting of the manufactured chewing gum pieces prior to coating thereby avoiding unnecessary coating or even problems related to the coating process of useless or leaking chewing gum pieces.

The orientating may be established e.g. be mechanically feeding the pieces in certain tracks or using dedicated feeder.

The flat portion(s) of the chewing gum tablet may be introduced as two opposite, substantially symmetric sides, which have been flattened by means of pressure by a piston. Alternatively or additionally, a flat portion of the chewing gum tablet may be constituted of a flat belt in the outward appearance of the chewing gum substance and thus in a circumference of the tablet.

1. Chewing gum piece comprising at least one inner filling being enclosed by sugarless chewing gum substance, said chewing gum piece being provided with an anti-sticking agent, and said chewing gum piece being provided with a coating at least partly encapsulating said chewing gum piece and said anti-sticking agent.

2. Chewing gum piece according to claim 1, wherein said chewing gum piece comprises at least one substantially flat portion.

3. Chewing gum piece according to claim 1, wherein said chewing gum piece comprises at least two, substantially parallel, substantially flat portions.

4. Chewing gum piece according to claim 1, wherein said chewing gum piece has flat areas comprising at least 5%, of the total surface area of said chewing gum piece.

5. Chewing gum piece according to claim 1, wherein said chewing gum substance comprises a polymer portion and at least two ingredients selected from the group consisting of flavors, sweeteners, softeners, fillers, colorants, waxes, fats, surfactants, antioxidants, active ingredients, and combinations thereof.

6. Chewing gum piece according to claim 5, wherein said polymer portion comprises at least one polymer.

7. Chewing gum piece according to claim 5, wherein said chewing gum substance comprises a gum base, of which said polymer portion constitutes a main part.

8. Chewing gum piece according to claim 7, wherein said gum base comprises 20 to 80%, preferably 30 to 60% by weight of the chewing gum substance.

9. Chewing gum piece according to claim 7, wherein said gum base comprises bubblegum base in an amount of 2 to 100% by weight of the gum base.

10. Chewing gum piece according to claim 7, wherein said gum base comprises polyvinyl acetate of high molecular weight (Mw) of about 20000-70000 g/mol in an amount in the range of 0.1%-20% by weight of the chewing gum substance.

11. Chewing gum piece according to claim 7, wherein said gum base comprises fat in an amount of 0.001% to 5% by weight of the gum base.

12. Chewing gum piece according to claim 7, wherein said gum base comprises high molecular weight elastomer of molecular weight of about 300000 to 400000 g/mol in an amount of at most 3% by weight of the chewing gum substance.

13. Chewing gum piece according to claim 1, wherein said chewing gum substance forms a wall enclosing said inner filling in substantially all directions.

14. Chewing gum piece according to claim 13, wherein said wall has an average thickness in the range of about 0.5 to 10 mm.

15. Chewing gum piece according to claim 1, wherein said chewing gum substance comprises at least one active ingredient.

16. Chewing gum piece according to claim 15, wherein said at least one active ingredient is comprised in a gum base.

17. Chewing gum piece according to claim 1, wherein said chewing gum substance comprises at least one biodegradable polymer.

18. Chewing gum piece according to claim 17, wherein said at least one biodegradable polymer comprises a polyester.

19. Chewing gum piece according to claim 18, wherein said polyester is obtainable from ring-opening polymerization of one or more cyclic esters.

20. Chewing gum piece according to claim 18, wherein said polyester is obtainable from polymerization of at least one alcohol or derivative thereof with at least one carboxylic acid or derivative thereof.

21. Chewing gum piece according to claim 1, wherein said chewing gum substance comprises at least two different polyesters.

22. Chewing gum piece according to claim 1, wherein said chewing gum piece weighs in the range of 0.5 to 8 grams.

23. Chewing gum piece according to claim 1, wherein said chewing gum piece is shaped as a pellet, chunk, stick, cushion, pastille, ball, pill, or sphere.

24. Chewing gum piece according to claim 1, wherein said inner filling comprises of 2 to 40% by weight of said chewing hum piece.

25. Chewing gum piece according to claim 1, wherein said inner filling is at least partially solid at a temperature of at most 5° C.

26. Chewing gum piece according to claim 1, wherein said inner filling is at least partially solid at temperatures up to 30° C.

27. Chewing gum piece according to claim 1, wherein said inner filling comprises components selected from the group consisting of syrups, pastes, powders, and mixtures thereof.

28. Chewing gum piece according to any of the claim 1-27, wherein said inner filling has a viscosity in the range of 0.6 to 200000 mPa*s as measured at 40° C.

29. Chewing gum piece according to claim 1, wherein said inner filling comprises at least one sweetener and at least one flavor.

30. Chewing gum piece according to claim 1, wherein said inner filling comprises at least one sweetener selected from the group consisting of mannitol, xylitol, hydrogenated starch hydrolysates, maltitol, isomaltol, erythritol, lactitol, sucrose, dextrose, maltose, dextrins, trehalose, D-tagatose, invert sugar, fructose, levulose, galactose, corn syrup, sucralose, aspartame, salts of acesulfame, alitame, neotame, twin sweet, saccharin and its salts, cyclamic acid and its salts, isomalt, dihydrochalcones, glycyrrhizin, dihydrochalcones, thaumatin, monellin, talin, stevioside, and mixtures thereof.

31. Chewing gum piece according to claim 1, wherein said inner filling comprises at least one flavoring agent selected from the group consisting of essential oils, fruit flavors, peppermint, spearmint, wintergreen, cinnamon, lemon, orange, lime, grapefruit, grape, strawberry, pineapple, cherry, apple, and mixtures thereof.

32. Chewing gum piece according to claim 1, wherein said inner filling comprises active ingredients.

33. Chewing gum piece according to claim 1, wherein said inner filling is situated at least approximately in the center of said chewing gum piece.

34. Chewing gum piece according to claim 1, wherein said inner filling is situated in at least two partly separated compartments in said chewing gum piece.

35. Chewing gum piece according to claim 1, wherein said anti-sticking agent is located on the outside of said chewing gum piece and on the inside of said coating.

36. Chewing gum piece according to claim 1, wherein said anti-sticking agent is selected from the group consisting of calcium hydroxide, talc, D-mannitol, silicon dioxide, sucrose ester, calcium stearate, zinc stearate, magnesium stearate, a metallic stearates, polyoxyethylene monostearates, silicates, polyethylene glycols, silicate dioxide, fumed silica, stearic acid, calcium carbonate, and mixtures thereof.

37. Chewing gum piece according to claim 1, wherein said coating is selected from the group consisting of hard coatings, soft coatings, and film coatings.

38. Chewing gum piece according to claim 1, wherein said coating comprises about 1 to about 85% by weight of the complete coated chewing gum piece.

39. Chewing gum piece according to claim 1, wherein said coating is formed from layers of liquid suspensions applied consecutively in 1 to 100 coating cycles.

40. Chewing gum piece according to claim 1, wherein said coating comprises ingredients selected from the group consisting of sweetening syrups, high intensity sweeteners, flavors, and active ingredients.

41. Chewing gum piece according to claim 1, wherein said coating is sugarless or sugar free.

42. Chewing gum piece according to claim 1, wherein said coating is a hard coating comprising at least one polyol component selected from the group consisting of sorbitol, maltitol, mannitol, xylitol, erythritol, lactitol, isomalt, and mixtures thereof.

43. Chewing gum piece according to claim 1, wherein said coating is a film-coating comprising at least one component selected from the group consisting of wax, cellulose derivatives, a modified starches, dextrins, gelatine, shellac, gum arabics, zein, vegetable gums, synthetic polymers, and mixtures thereof.

44. Chewing gum piece according to claim 1, wherein the chewing gum piece is formed on the basis of a substantially non-cooled chewing gum material.

45. Method of manufacturing chewing gum pieces comprising
continuously extruding sugarless or sugar free chewing gum substance rope comprising an inner filling from an extruder to a tablet forming arrangement, said tablet forming arrangement continuously forming and cutting chewing gum pieces from said rope:
continuously providing an anti-sticking agent to said rope subsequent to said extrusion and at least simultaneously or prior to said forming and cutting;
providing a sugarless or sugar free coating to said chewing gum pieces by means of a coater.

46. Method of manufacturing a chewing gum piece according to claim 1, said method comprising
continuously extruding sugarless or sugar free chewing gum substance rope comprising an inner filling from an extruder to a tablet forming arrangement, said tablet forming arrangement continuously forming and cutting chewing gum pieces from said rope,
continuously providing an anti-sticking agent to said rope subsequent to said extrusion and at least simultaneously or prior to said forming and cutting,
providing a sugarless or sugar free coating to said chewing gum pieces by means of a coater.

47. Method according to claim 46, further comprising rope sizing said chewing gum substance rope by means of at least one rope sizer subsequent to said extrusion and prior to said forming and cutting.

48. Method according to claim 46, whereby said anti-sticking agent is applied at two or more positions during said method.

49. Method according to claim 46, whereby said anti-sticking agent is applied prior or simultaneously to a rope sizing.

50. Method according to claim 46, whereby said anti-sticking agent is applied on the way out of said extruder.

51. Method according to claim 46, whereby said anti-sticking agent is applied onto the surface of the chewing gum substance rope.

52. Method according to claim 46, whereby said anti-sticking agent is applied onto a part of a rope sizer or tablet forming arrangement being in contact with said chewing gum substance rope.

53. Method according to claim 46, whereby said anti-sticking agent is applied by a conditioning arrangement by spraying, dusting, or smearing.

54. Method according to claim 46, whereby said extrusion and said forming and cutting is performed substantially without cooling.

55. Method according to claim 47, whereby said extruder, rope sizer, and tablet forming arrangement are operated at a temperature of at least 30° C.

56. Method according to claim 46, whereby said chewing gum pieces are cooled prior to coating or storage to a temperature of at most 30° C.

57. Method according to claim 46, whereby said chewing gum substance rope has a diameter in the range of 5 to 50 mm.

58. Method according to claim 46, whereby said chewing gum substance forms a wall surrounding said inner filling.

59. Method according to claim 58, whereby said wall has a thickness in the range of 0.5 to 10 mm.
